(19) United States
(12) Patent Application Publication
(10) Pub. No.: US 2009/0019552 A1
(43) Pub. Date: Jan. 15, 2009

(54) Healthcare Medical Information Management System

(76) Inventors: Mark R. McLaughlin, Atlanta, GA (US); Seth A. Yellin, Atlanta, GA (US); Wayne J. Singer, Atlanta, GA (US)

Correspondence Address: COURTNEY STANIFORD & GREGORY LLP, P.O. BOX 9686, SAN JOSE, CA, 95157, US

(21) Appl. No.: 12/168,835

(22) Filed: Jul. 7, 2008

Related U.S. Application Data
(63) Continuation-in-part of application No. 11/037,842, filed on Jan. 18, 2005.
Application No. 11/037,842 is a continuation of application No. 09/717,906, filed on Nov. 20, 2000, now abandoned.
(60) Provisional application No. 60/958,378, filed on Jul. 5, 2007.
(60) Provisional application No. 60/957,243, filed on Aug. 22, 2007.
(60) Provisional application No. 60/968,012, filed on Aug. 24, 2007.
(60) Provisional application No. 60/189,527, filed on Mar. 15, 2000.

(51) Int. Cl. G06F 21/00; G06Q 20/00; G06Q 10/00; G06Q 50/00

(52) U.S. Cl. 726/27; 705/35; 705/10; 705/3

(57) ABSTRACT

A medical information management system and corresponding methods are described for providing access to healthcare records. The system includes a database system comprising healthcare records of a patient, a healthcare workstation coupled to the database system and an authentication system comprising a processor coupled to the database system. The healthcare workstation is located at a treatment facility or point of treatment that is remote to the database system. The authentication system generates an image of a finger of the patient at the point of treatment, and generates from the image an identification number. The authentication system compares the identification number to a stored number corresponding to the patient, and authenticates the patient's identity when the comparison produces a match between the identification number and stored number. Access to the healthcare records is controlled via the healthcare workstation in response to authentication of the patient.

### CROSS-REFERENCE TO RELATED APPLICATIONS

This application claims the benefit of United States (US) Patent Application No. 60/958,378, filed Jul. 5, 2007.

This application claims the benefit of U.S. Patent Application No. 60/957,243, filed Aug. 22, 2007.

This application claims the benefit of U.S. Patent Application No. 60/968,012, filed Aug. 24, 2007.

This application is a continuation in part of U.S. patent application Ser. No. 11/037,842, filed Jan. 18, 2005, which is a continuation of U.S. patent application Ser. No. 09/717,906, filed Nov. 20, 2000, now abandoned, which claims the benefit of the filing date of U.S. Patent Application No. 60/189,527, filed Mar. 15, 2000.

### TECHNICAL FIELD

The embodiments herein relate generally to electronic healthcare record storage and retrieval and, more specifically, to systems and methods in which security of the patient's records are controlled primarily by the patient.

### BACKGROUND

Patient medical information is primarily maintained in a fragmented, paper-based system. Such information is rarely shared among medical providers due to difficulty in obtaining legible records in a timely fashion. Furthermore, patients often lack detailed knowledge of their own medical history. As a result of these shortcomings, healthcare providers are often practicing medicine with partial information, which creates the possibility for errors. This error factor is multiplied greatly in emergency situations.

Methods exist that address pieces of the medical errors problem but do not provide a total solution. For example, to address prescription errors, there are hand-held or desktop computer devices that avoid the problem of legibility with handwritten prescriptions. There are also systems that capture medical records electronically within a hospital or similar medical facility, but they do not share them securely and seamlessly with other medical professionals outside the facility. There are also data storage systems that are specific to a given population but are not able or allowed to communicate with other such databases due to the proprietary nature of the systems. In addition, systems are known in which a patient carries a medical information card from which insurance information can be electronically read by a healthcare provider using an appropriate magnetic stripe reader or similar device.

More comprehensive systems have been suggested in which patients are issued smart cards. “Smart card” is the common term for a credit card-like device that has an embedded microprocessor or other digital processing logic and a digital memory. The cards have memory in which is stored biographical information about the patient as well as medical information such as blood type, chronic conditions, allergies, immunizations and drug prescriptions. Some such systems have card readers that can communicate with a centralized database in which related information is stored. Using smart cards to transmit prescriptions from a physician to a pharmacist has also been suggested. There is a need for a system that facilitates access to patient medical information yet allows the patient to maintain primary control over his or her private information.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

The accompanying drawings illustrate one or more embodiments and, together with the written description, serve to explain the principles of the systems and methods described herein. Wherever possible, the same reference numbers are used throughout the drawings to refer to the same or like elements of an embodiment, and wherein:

FIG. 1 illustrates a system in which base units operated by various types of healthcare professionals access a database of patient medical information secured against unauthorized access by patient smart cards and patient finger image biometrics;

FIG. 2 is a generalized perspective view of a system in which a base unit is coupled to a desktop computer;

FIG. 3 is a generalized perspective view of a base unit having an integral display, keyboard and wireless network access;

FIG. 4 is a block diagram of a base unit similar to that of FIG. 3; and

FIG. 5 is a flow diagram illustrating a method of operation of the system.

FIG. 6 is a block diagram of healthcare medical information management system, under an embodiment.

FIG. 7 is a block diagram of healthcare medical information management system that includes the authentication system, where the authentication system includes a terminal and a server, under an embodiment.

FIG. 8 is a flow diagram of a method for controlling electronic access to healthcare records, under an embodiment.

FIG. 9 is a block diagram of the interface, under an embodiment.

FIG. 10 is a block diagram of an example large scale configuration of the healthcare medical information management system, under an embodiment.

FIG. 11 is a block diagram of an example small scale configuration of the healthcare medical information management system, under an embodiment.

### DETAILED DESCRIPTION

Systems and methods are described below in which a smart card or other electronic token possessed by a patient and a biometric identification of the patient are used in combination to limit access to electronically stored patient information to authorized healthcare professionals. Healthcare professionals to whom access is authorized can include, for example, physicians, dentists, nurses, pharmacists, laboratory personnel and others. Because the patient controls the use of the smart card and biometric identification, the patient effectively controls the authorization.

Patient healthcare information, such as medical diagnoses, treatments, caregiver comments and impressions, medications, test results, diagnostic data and the like, are primarily stored in a secure database system that can be referred to as an electronic vault and is located remotely from the healthcare professional's clinic, office, hospital or other site. Each patient is issued an electronic token, which can be card-like, pendant-like or have any other suitably portable shape or structure. The patient's name and other such biographical information are stored in the memory of the token itself. An identifier is also stored in the token memory and is used as an index to the corresponding patient records stored in the database system. To ensure privacy, no biographical information or other personal information revealing the patient's identity is stored in the database system. The patient's insurance information may also be stored in the token memory. Vital medical information, such as the patient's blood type, current medications, allergies to medicines, emergency contacts, and other information that could be needed by emergency medical personnel, may also be stored in the token memory. Information stored in token memory is encrypted to safeguard against unauthorized access and tampering.

At the healthcare professional's site or other place at which the patient receives services, an electronic base unit that can communicate with the database system via a wide-area network such as the Internet verifies the patient's identity by obtaining a biometric from the patient and comparing it to corresponding information stored in the token memory. The biometric is one known to uniquely identify a person and can be, for example, finger images, voice print, iris or retinal pattern, genetic marker, facial feature, or anything else that can be obtained by electronically sensing and analyzing an element of a person's body. If the patient's identity is verified in this manner, the healthcare professional can use the base unit, which may be connected to the professional's computer system, to access patient records in the database system and information stored in the token. In certain circumstances, such as when no network access is available in emergency situations, it may be expedient or otherwise useful to access information stored in the token memory without accessing information stored in the database system. The base unit can have any suitable structure and can be a stand-alone device or integrated with another device, such as a computer system or a Personal Digital Assistant (PDA). In circumstances in which the healthcare professional is mobile, such as in an ambulance, the base unit can be, for example, a portable device with wireless network access and an integral display.

The system can be used not only by primary caregivers but also by pharmacists, diagnostic technicians, laboratory personnel, and other healthcare professionals who similarly do not require access to the healthcare information stored in the database system. For example, a physician's base unit can store a prescription in the token memory. A pharmacist's base unit can read the memory to obtain the prescription, and when the pharmacist has filled the prescription the base unit can store an indication of that fact in the token memory. When the patient returns to the physician for a follow-up visit, the physician's base unit can read the memory to allow the physician to determine if the prescription was filled and, if so, when.

It is to be understood that both the foregoing general description and the following detailed description are examples only and are not to restrict the systems and methods described herein to only the systems and methods described herein. Although the illustrated embodiments relate to a medical environment, the systems and methods described herein are applicable to other healthcare environments as well, such as dental, for example. The following is intended to illustrate example ways to make and use what is regarded as the invention, the scope of which is to be defined solely by the appended claims.

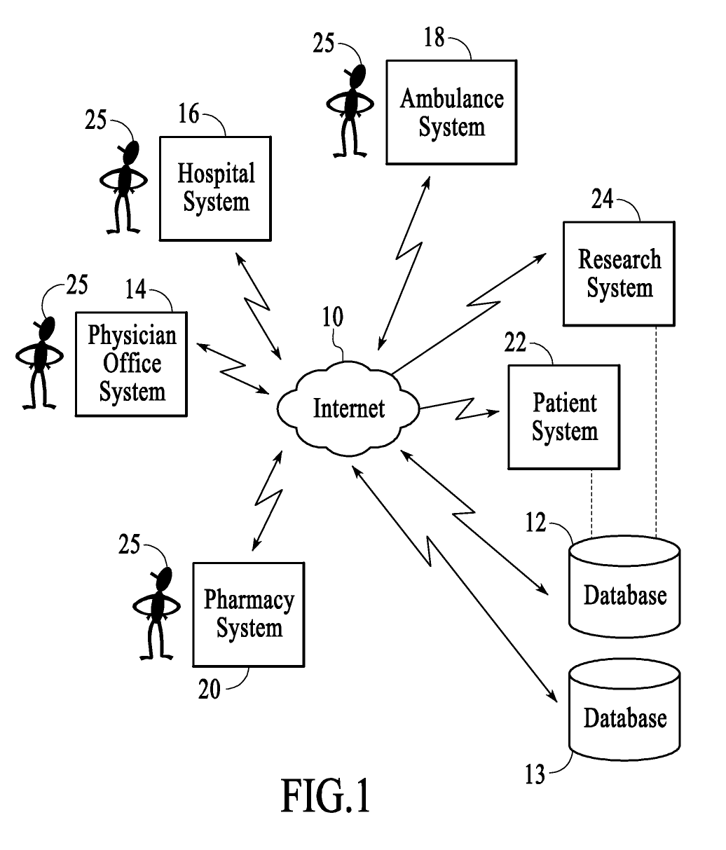

As illustrated in FIG. 1, the Internet 10 provides a medium for data communication between databases 12 and 13 and remote systems 14, 16, 18 and 20 operated by various healthcare professionals and between database 12 and systems 22 and 24. System 14, for example, is located within a physician's office; system 16 is located within a hospital; system 18 is a mobile system located within an ambulance; and system 20 is located within a pharmacy. These locations are merely examples of sites at which the healthcare professionals who staff them can use the embodiments herein, and in other embodiments similar systems can be located at other sites staffed by other types of healthcare professionals. Note that embodiments can have systems located at more or fewer types of sites than those illustrated. Along the same lines, embodiments can have many systems used by each such type of health professional. For example, although only a single physician office system 14 is illustrated for purposes of clarity, an embodiment can have hundreds or thousands of systems 14 used by hundreds or thousands of physicians throughout the country or the world. As described below in detail, patients 25 interact with these remote systems by allowing their finger images to be scanned and presenting smart cards that have been issued to them. Finger image information database 13 is used to store scanned finger image numeric information, as described below.

Communication between the healthcare information database 12 and other components via the Internet or other network is secure. As an example, a public key infrastructure (PKI) (not shown) may be interposed between healthcare information database 12 and Internet 10 to enable the enterprise that operates database 12 to provide authentication, access control, confidentiality and non-repudiation for its network applications. Because PKI 23 is well-known in the art, it is not described in detail herein. As persons skilled in the art to which the embodiments herein pertain will appreciate, it can perform the above-mentioned functions using advanced technologies such as digital signatures, encryption and digital certificates.

The term “Internet” as used in this patent specification refers to the global super-network or a portion thereof that is commonly known by that name and used to provide connectivity between remotely located computers for commercial, entertainment, educational, research and other purposes. Note that the Internet merely exemplifies a type of wide-area network that can be used in the embodiments herein, and other wide-area networks may be suitable. As well-understood in the art, the Internet is a client-server environment that operates in accordance with various protocols including those known as Internet Protocol (IP) and Transport Control Protocol (TCP). Also note that portions of the Internet may use wires as the physical medium while other portions may use radio communication links. Accordingly, the communication links illustrated in FIG. 1 can be wired (e.g., copper or optical cable) or wireless (e.g., radio). For example, the Internet communication link between ambulance system 18 and database system 12 is at least in part wireless.

Healthcare information database system 12 is a server computer system that can include suitable non-volatile storage media such as magnetic disk arrays, processing units, working memory, database software, operating system software, network communication software, and other hardware and software elements of the types commonly included in server computer systems that manage and provide access to large databases. The database itself can be a relational database. As explained in further detail below, medical information pertaining to patients is stored in database system 12. Database system 12 can be located at any suitable site and can be remote from any or all of systems 14, 16, 18, 20, 22 and 24. Database system 12 can be operated by a third party (i.e., neither a healthcare professional nor a patient), such as contracted by a business entity that enrolls patients in its service program, as described below in further detail.

Patient system 22 and research system 24 can be common personal computers through which medical information can be retrieved from database system 12. (The dashed lines between database system 12 and systems 22 and 24 are intended to indicate that systems 22 and 24 are, as described in further detail below, tied more directly to database system 12 than other remote systems and subject to different database access requirements than other remote systems.) Although not illustrated for purposes of clarity, such computers can access database system 12 via the World Wide Web (“Web”) using conventional Web browser software. As known in the art, a Web browser is a client program that effects the retrieval of hypertext documents (“pages”) from suitably configured Web servers. Web pages can also be forms that a user of the browser can fill in and transmit to a server. Database system 12 includes suitable server software to provide the information requested by patients in Web page format. An introductory or log-in page (not shown) requests the user enter a user name and personal identification number (PIN). If database system 12 determines that the entered user name and PIN are those of authorized users, it provides access to the stored medical information. System 12 permits patients to retrieve and review their own medical records, but not those of others. However, for security purposes, their identities remain screened by a multi-digit alphanumeric sequence. Authorized researchers such as government agencies can likewise be permitted limited access, such as reports derived from aggregate data with no individual's identifiable information, as described in further detail below.

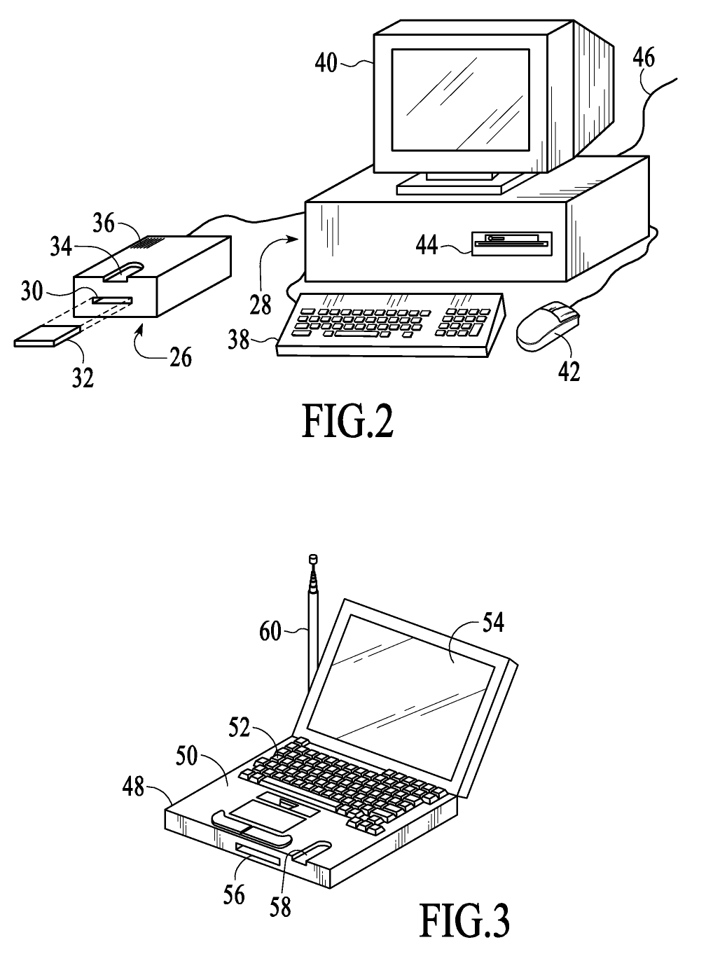

As illustrated in FIG. 2, any or all of the remote systems described above can include a base unit 26 in communication with a computer 28. Nevertheless, in other embodiments the relevant hardware and software logic and other elements of base unit 26 and computer 28 can be integrated within a single device. In still other embodiments, they can be integrated with other types of portable or non-portable devices.

In an embodiment, base unit 26 has a reader/writer unit 30 with a slot into which a smart card 32 can be inserted to read data from and write data to card 32. As well-known in the art, a smart card is an electronic device having a card-like housing in which circuitry, including a processor, memory and associated logic (not shown), operate to perform mathematical, data manipulation or other logical operations in accordance with suitable programming. Reader/writer unit 30 interfaces with card 32 via electrical contacts (not shown) on card 32. Nevertheless, in other embodiments this interface can be any of the equally well-known magnetic, contactless, inductive, radio frequency or other wireless types. The structures and operation of smart card 32 and reader/writer unit 30 are well-understood by persons skilled in the art and are therefore not described in detail in this patent specification. Although smart “cards” are contemplated, pendant-like devices as well as pager-like and computer-like wireless devices are known that can perform similar functions. The token could likewise be included in a wristwatch or similar jewelry-like device. Therefore, not only smart cards but any other suitable electronic token can be included. In embodiments having wireless interfaces, the token is typically passed within a prescribed proximity of the target to achieve data communication between them. Although utilizing smart cards or tokens are described above, this application does not madate their use. The device could also match the profile against a finger image profile in a database.

Base unit 26 further includes a finger image scanner 34 and a speaker 36. As described in further detail below, to use the system a patient's finger is placed on scanner 34 when smart card 32 is inserted into reader/writer 30. A finger image scan determines whether the patient's finger image matches a profile that has been previously obtained and stored in a memory of card 32 or in a finger image database 13. The combination of card 32 or finger image database 13 and the finger image serve to verify the patient's identity. A unique biological characteristic of a person that can be measured and identified is known in the art as a biometric. Examples of well-known biometrics that can be electronically measured and identified include not only finger images but also iris or retinal patterns, voice prints, facial features, and genetic markers. Finger image scanner 34 and its operation are well-known in the art and therefore not described in further detail in this patent specification. Although finger image identification is included in the illustrated embodiment, in other embodiments other suitable biometric comparisons can be included, such as iris, retinal, voice print, facial feature or genome identification. In such other embodiments, in place of finger image scanner 34 a corresponding measurement or sampling device is included.

Computer 28 can be a conventional personal computer having a keyboard 38, monitor 40, mouse 42, floppy disk drive 44 and other hardware and software elements commonly included in personal computers. In a physician's office or hospital, it can be the computer system that is otherwise used apart from the embodiments herein for maintaining records, calendaring appointments, accounting, and other administrative tasks, or it can be a separate computer. In addition, computer 28 has network communication hardware and software, a modem or other hardware and software that enables data communication with remote servers. A suitable cable 46 connects computer 28 to a telephone exchange, a local-area network server, cable media network, or other intermediate system or systems (not shown) that are ultimately connected to Internet 10 (FIG. 1) in the conventional manner.

An alternative remote system is illustrated in FIG. 3. In contrast to the system illustrated in FIG. 2, in this system the base unit 48 integrates the above-described elements of the remote system into a single unit having wireless Internet communication capability. Base unit 48 thus includes a housing 50, keyboard 52, display 54, smart card reader/writer unit 56 and a finger image scanner 58, as well as an antenna 60. Housing 50 can resemble that of a conventional laptop computer, with the portion of housing 50 in which display 54 is retained foldable along a hinge against the remaining portion of housing 50. In other embodiments, base units can be miniaturized and resemble devices commonly referred to as personal digital assistants, cellular telephones, pagers or other conventional wireless devices and hybrids thereof. Except as specifically noted (e.g., wired as opposed to wireless communication), the remote system illustrated in FIG. 2 operates in essentially the same manner as that illustrated in FIG. 3. Therefore, the following description of the structure and operation of base unit 48 is generally applicable to other remote systems, the structure and operation of which may not be described in similar detail in this specification for purposes of clarity.

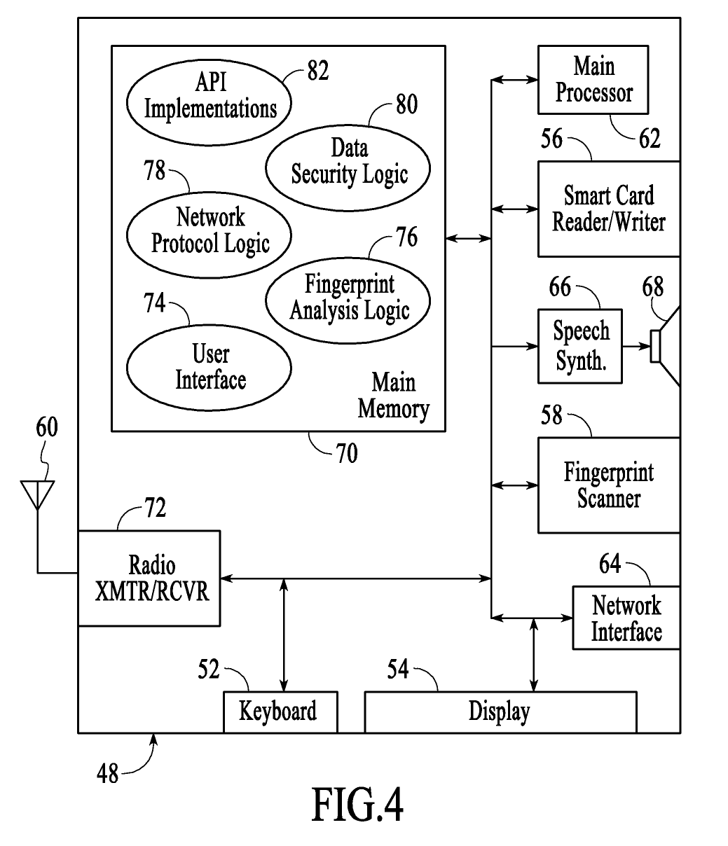

As illustrated in FIG. 4, base unit 48 includes, in addition to the elements described above, a main processor 62, a network interface 64, a speech synthesizer 66 and associated speaker 68, a main memory 70 and a radio transceiver 72. Processor 62 can include any suitable type or number of microprocessors, micro-controllers, central processing units or similar processors and any associated hardware, software and firmware. Network interface 64 represents the hardware and software necessary to enable base unit 48 to communicate with remote computers via a (wired) local-area network (LAN). Radio transceiver 72 similarly represents the hardware and software necessary to enable base unit 48 to communicate with remote computers, but via a wireless communication link rather than a wired link. As described above, base unit 48 can communicate via the Internet using either the wireless link or the wired LAN. In some circumstances, such as when base unit 48 is used in an ambulance or other mobile site, no wired connections are available, and network communication must be wireless.

Main memory 70 represents the random access memory in which most executable software and data are at least temporarily stored. Although not illustrated for purposes of clarity, base unit 48 can include data storage media of other types commonly included in computers, such as read-only memory, a floppy disk drive, hard disk drive, and removable disk drive (e.g., optical or magnetic media). Base unit 48 operates in accordance with its programming, which can be embodied in any suitable combination of software, firmware, hardware or other logic encoded in such memory and storage devices or retrieved remotely via a networked device. The programming of base unit 48 can be structured or organized in any suitable manner, but for illustrative purposes can include the following software modules: a user interface 74, finger image analysis logic 76, network protocol logic 78, data security logic 80 and application program interface (API) implementations 82. These modules operate collectively and in concert with database system 12 (FIG. 1) to effect the methods described below. Persons skilled in the art will appreciate that, like any software, processor 62 executes these modules by fetching instructions from memory 70, and that the modules, to the extent the programming is actually composed of such distinct modules, may not exist in their entirety or simultaneously in memory 70 at any given time. Rather, the modules are shown as they are (i.e., distinctly identifiable and residing simultaneously in memory 70 in their entireties for execution) for purposes of illustration only. As is common in the art, portions of the software can be loaded into memory 70 on an as-needed basis from a hard disk drive (not shown) or from a remote computer (not shown) via a network. Alternatively, some or all of the software can be encoded into read-only memory as firmware. Indeed, modules 74, 76, 78, 80 and 82 or similar software elements can be remotely located from one another in a distributed networked computing environment of the types that are becoming increasingly common. Note that the software as stored on or otherwise carried on a removable disk, network medium or other such computer-usable medium constitutes a “program product” that in part embodies the systems and methods described herein. The systems and methods described herein are also embodied in the above-described remote systems as programmed with the relevant software. The systems and methods described herein are also embodied in the computer-implemented methods or processes.

User interface 74 provides the functionality for interacting with the patient and healthcare professional. It controls what is displayed on display 54, received via keyboard 52, and spoken via speech synthesizer 66 and speaker 68. Information can be displayed in a graphical format using conventional windowing principles. Medical information can be displayed in a tabbed format that resembles a traditional patient medical chart. Finger image analysis logic 76 controls finger image scanner 34, captures the patient's finger image and compares it to corresponding information stored in smart card 32 or in a hosted database. Network protocol logic 76 controls data communication via wired network interface 64 and via the wireless network interface of transceiver 72. Network protocol logic 78 represents the software layer that encodes, decodes and formats data in accordance with communication protocols such as TCP/IP. Data security logic 80 operates in conjunction with finger image analysis logic 76 and smart card reader/writer unit 56 to permit a query to be transmitted via the appropriate network to database 12 if the patient's identity is verified. API implementations 82 can be accessed by devices connected to base unit 48 if it is desired to coordinate the functions of base unit 48 with a computer or other device. For example, if base unit 48 is connected to computer 28 (FIG. 2), software executing on computer 28 can make API calls to base unit 48 to control the communication of data, scanning of finger images and other functions. Such coordination may be desirable if practice management software executing on computer 28 requires data from base unit 48. Note that, although not shown for purposes of clarity, the same API functionality is included in base unit 26 (FIG. 2) to enable it to be controlled by computer 28 in the manner indicated.

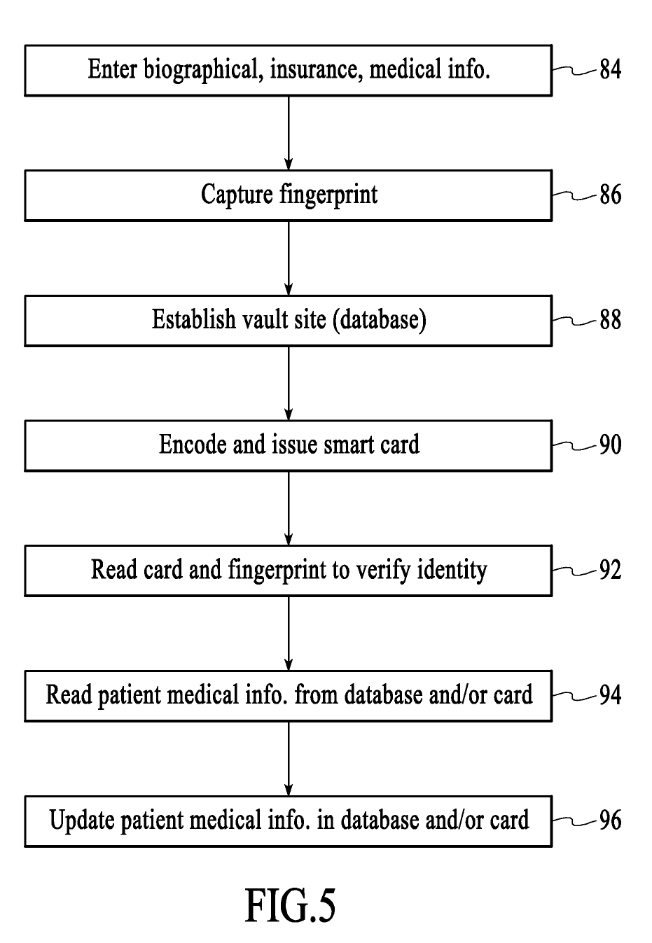

A method of operation in accordance with the embodiments herein is illustrated by the flowchart of FIG. 5. In view of the following description of the method steps, persons skilled in the art will readily be capable of writing or otherwise providing suitable software for base unit 48 and other remote systems as well as for database system 12 (FIG. 1).

A person, including not only a patient but also an authorized healthcare provider, can enroll in a program or plan administered by a third party that contracts with the host of the database system 12 and controls the distribution and use of base units and smart cards. Steps 84, 86, 88 and 90 relate to the enrollment procedure. The program allows such persons and their healthcare providers to receive the benefits of using the embodiments described herein.

At 84 a person (hereinafter referred to as the patient) begins the enrollment procedure at an enrollment center operated or licensed by or on behalf of the third party administrator. Alternatively, 84 can be performed via the Internet (e.g., using patient system 22) by accessing a suitable website such as one maintained by the third party who maintains control of database system 12. Biographical information, insurance information and comprehensive medical information are entered into a suitable electronic form (not shown). The biographical information includes the patient's name, residence, identification number (e.g., in the U.S.A., a Social Security Number) and other personal information that identifies or describes the patient. The medical information includes lifesaving or vital medical information such as chronic illnesses or conditions, medications the patient is then taking, allergies, blood type, name and address of person to contact in an emergency, and other information that could be critically useful to emergency medical personnel. The medical information can also include other information of which the patient is aware, such as immunization history, past illnesses, surgical interventions, hospitalizations, family medical histories, and self-prescribed medical/pharmaceutical care. The healthcare provider completes a similar administrative enrollment process to participate in the chain of custody required to handle medical information as described herein.

At 86 the patient's finger image is captured, either at the enrollment center or when the patient visits a healthcare provider equipped to capture finger images for the program. The devices and methods by which finger images are captured for automated biometric analysis are well-known and therefore not described in this patent specification. In essence, however, the method involves obtaining a digitized image of the finger image and extracting a set of characteristics known as minutiae that uniquely identify the finger image. At 87 this finger image information is electrically transmitted to finger image profile database 13. Database 13 stores the finger image information to allow the healthcare provider to re-issue a smart card 32 to a patient who has misplaced his originally issued smart card 32 or who otherwise is not in possession of it when he visits the provider. Database 13 may not have direct connection to database 12 and is located at a site remote from that at which database 12 is located.

At 88 a vault site for the patient is established in database system 20. The term “vault” refers to the security with which the patient's medical information is guarded against unauthorized access. Each patient enrolled in the program has a vault of one or more database records in which his or her medical information is stored. Nevertheless, the data can be organized in any suitable manner in accordance with well-known relational database principles. The vault is indexed by a unique alphanumeric identifier; no two patients' vaults have the same identifier. The identifier can be randomly generated or generated using a hash algorithm such that it does not reveal the patient's identity. The system preserves a patient's privacy by not storing the biographical information or other identifying information in the vault. Rather, only the medical information itself is stored in the vault. During this portion of the enrollment procedure, some of the medical information entered by the patient can be stored in the vault. If available, historical medical information obtained from physicians or others who have provided medical care for the patient can also be stored in the vault at this time.

At 90 smartcard 32 is created and issued to the patient. The finger image or other biometric information as well as insurance information and vital medical information that the patient entered are encrypted and stored in the card memory. The patient is given smart card 32. When the patient visits a healthcare provider or other healthcare professional to obtain services the patient brings smart card 32 with him. Note that an appropriate subset of enrollment steps 84-90 can be performed at the provider's site if, as mentioned above, a patient is no longer in possession of his smart card 32 when he visits the provider. The finger image information can be retrieved from database 13 and stored in the card memory. If a provider reissues a smart card 32 to a patient under such circumstances, the previously issued smart card 32 is rendered inoperative.

An alternative to use of a smart card eliminates the smart card. Under this alternative, when the patient visits a healthcare provider or other healthcare professional to obtain services, the IntelliFinger device retrieves or reads from a remote system (e.g., EHR, database, etc.) the information that might be found on the smart card in an embodiment using the smart card. In this manner, a patient would not be required to carry a smart card or other device that included personal information.

Steps 92, 94 and 96 occur when the patient visits a healthcare professional. In an example scenario in which the patient visits a physician's office, at 92 the patient inserts smart card 32 into reader/writer unit 30 (FIG. 2) and places his finger on scanner 34. Through speaker 36 base unit 26 may issue a voice announcement acknowledging the patient by name and requesting that he or she be seated to await the physician. Base unit 26 scans the patient's finger image, reads and decrypts the corresponding finger image information stored in smart card 32 and, if they match, permits encrypted data to thereafter be transferred between base unit 26 and database system 12 via the Internet at 94. It also permits the biographical, vital medical, insurance and other information retrieved from card 32 to be displayed for the physician on display 40 of computer 28 at 94. A physician can, for example, retrieve a patient's medical information from database 12 to familiarize himself with the patient's history. As noted above, the information is displayed in conventional medical chart format. Following diagnosis or treatment, at 96 the physician can enter his diagnosis, any treatment the patient received, medications the physician gave to the patient or prescribed for the patient, pertinent test results, impressions, and any other relevant information of the type conventionally maintained in medical records. Standard diagnostic codes and procedure codes (e.g., those known respectively as ICD-9 and CPT codes) can be entered.

When the patient is ready to leave the office, he or she can again identify himself using smart card 32 and finger image scan, at which time any appropriate information, such as a drug prescription created by the physician, is transferred to card 32, as indicated by 96. At that time computer 28 also causes base unit 26 to encrypt and transmit the entered information to database system 12 for storage in the patient's vault. Note that base unit 26 accesses the patient's records using the index number stored in card 32. The patient's insurance information read from card 32 can be imported into the physician's billing software on computer 28 for billing purposes. Lastly, base unit 26 may issue a voice announcement thanking the patient and advising the patient that his records have been updated.

The system also facilitates physician access to related medical information not specific to the patient. For example, if a diagnostic code is displayed on a patient's chart, the physician can select it using mouse 42 or similar pointing device. In response to the selection, base unit 26 can retrieve from a medical content provider further information explaining the disease or other condition related to the code.

The system permits what is commonly known as delayed coding. That is, database system 12 can accept for storage information received from base unit 26 during a predetermined time window, beginning when base unit 26 first verifies the patient's identity upon arrival at the facility and ending a few days after the patient leaves the facility (e.g., after the patient is discharged from a hospital (having, e.g., system 16 shown in FIG. 1)). The number of days can be pre-selected or predetermined by appropriately programming the system. Base unit 26 can implicitly identify the facility in which it is located by transmitting its serial number or other identifying information to database system 12. Base unit 26 can write information to database system 12 during this delayed coding window, but can only read information from database system 12 during the time the patient is actually at the facility. Once the patient has checked out (i.e., base unit 26 has verified the patient's identity at the conclusion of the visit), that base unit 26 can no longer read information from database 12 until the patient returns to the facility for further care. A few days later at the end of the delayed coding window, database system 12 can no longer accept information for storage from that base unit 26 until the patient returns to the facility for further care. Note that the patient can interact with other base units 26, i.e., those located at facilities other than that which the patient previously visited, independently of and without regard to the delayed coding window or other status of base unit 26 at the facility previously visited. Card 32 is rendered void if the coding indicating death is entered to not allow further use of card 32 in a fraudulent manner.

Card 32 can act as an electronic prescription pad. The patient can take card 32 to a participating pharmacy (i.e., a pharmacy having, for example, system 20 shown in FIG. 1) to have a prescription filled. 94 is performed at a pharmacy having the same or similar base unit 26. The patient identifies himself using smart card 32 and finger image scan. If the patient's identity is verified, base unit 26 reads the prescription from card 32 and causes it to be displayed for the pharmacist. After the pharmacist fills the prescription, he or she can again identify himself using smart card 32 and finger image scan, at which time an indication is stored in card 32 that the prescription has been filled, as indicated by 96. The next time the patient visits the physician, this indication can be read from the card and displayed for the physician. The physician will be alerted by the absence of the indication if the patient has not filled the prescription. The indication can be graphically represented by, for example, a checkmark in a box on the patient's chart adjacent the prescription. In addition, pharmacists and physicians may track overuse of any particular medication that may have been prescribed by more than one physician in a short period of time. The device may also be used for Methadone usage tracking as is required by many States.

In another example scenario in which the patient is being transported by ambulance, at 92 emergency medical personnel can assist the patient by presenting smart card 32 (which may, for example be found in an unconscious patient's wallet) and the patient's finger to base unit 48 (FIG. 3). Base unit 48 is useful in mobile environments such as ambulances because its communication link with database system 12 is wireless. At 94 personnel can obtain the patient's medical records from database 12 and, at 96, update database system 12 to reflect the patient's condition and any treatment they provided. The integral display 54 and keyboard 52 enable base unit 48 to function independently of another local computer. In addition, even if the wireless Internet link is inoperable, e.g., malfunctioning, such personnel can access the potentially lifesaving medical information stored on card 32.

It is important to note that a patient's biographical or other identifying information and the patient's medical information are not combined at any site accessible to unauthorized parties, thereby preserving patient confidentiality. Nevertheless, researchers, government agencies and others (e.g., research system 24 in FIG. 1) who may benefit from analysis of aggregate medical data can retrieve data from database 12 or obtain reports generated on their behalf using data retrieved from database system 12. Confidentiality is preserved because the information identifying the patients is stored only on their smart cards and not available to such outside parties. As noted above, patients (e.g., patient system 22 in FIG. 1) can access their own medical records through a suitable, secure website interface. By retaining control of their smart cards 32, and the inherent control over their own finger images, patients are made to feel that they themselves have control over the dissemination of their medical information.

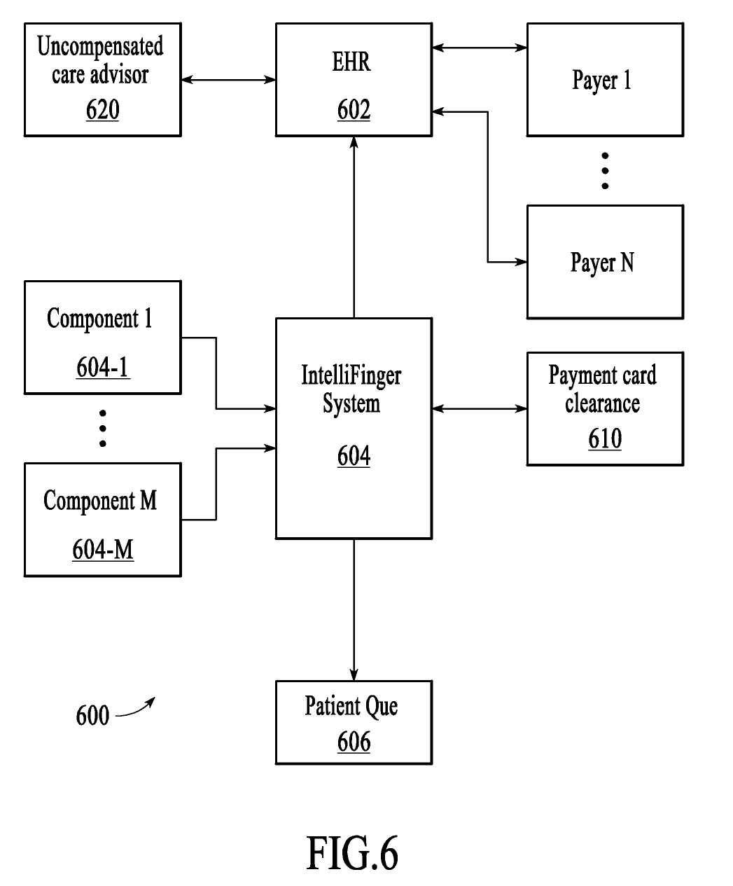

As a more specific example of the patient system 22 and remote systems 14, 16, 18, and 20 described above with reference to FIG. 1, FIG. 6 is a block diagram of healthcare medical information management system 600, under an embodiment. The healthcare medical information management system 600 includes an electronic health record (EHR) system or device 602 coupled to an authentication system 604. The authentication system 604 of an embodiment is also referred to herein as the IntelliFinger™ (“Intellifinger”) system 604, which includes the IntelliFinger device, but the authentication system is not limited to this device. The healthcare medical information management system 600 of an embodiment also includes a patient que 606, couplings or connections with an Uncompensated Care Advisor™ and any number N of third-party payers (where N is any number 1, 2 . . . N), and couplings or connections with any number of payment card services (e.g., credit card, debit card, etc.). The patient queue can be integrated with or a component of the EHR system 602 but is not so limited. The healthcare medical information management system 600 can also couple or connect to and/or integrate with one or more other systems (not shown).

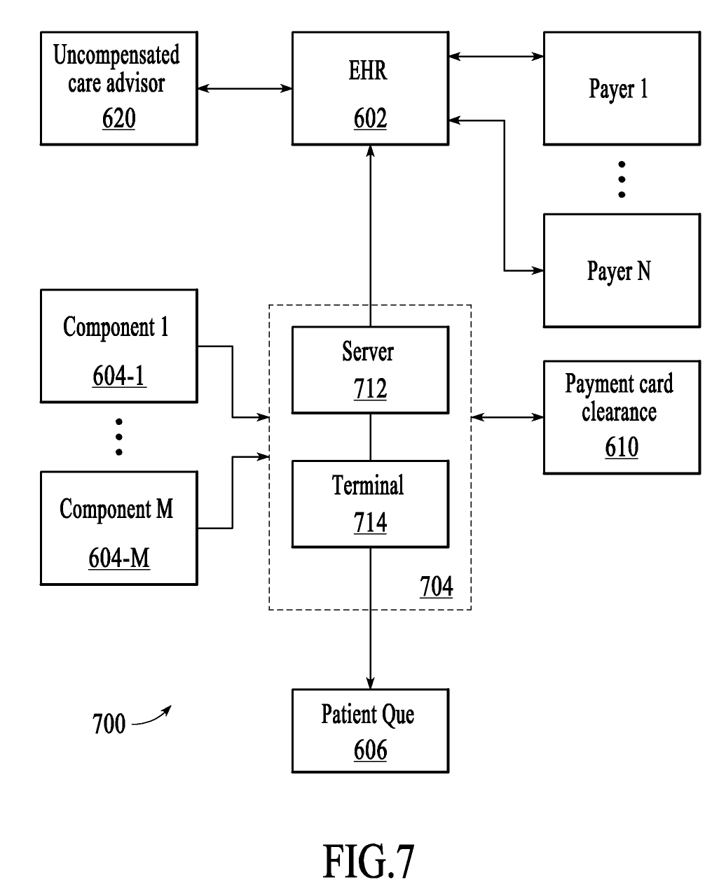

FIG. 7 is a block diagram of healthcare medical information management system 700 that includes the authentication system 704, where the authentication system 704 includes a terminal 714 and a server 712, under an embodiment. The terminal 714 is also referred to herein as the “authentication terminal” 714 and the server is also referred to herein as the “matching server” 712. The authentication terminal 714 of an embodiment includes the IntelliFinger device, but the authentication system is not limited to this device. The healthcare medical information management system 700 includes an electronic health record (EHR) system or device 602 coupled to the authentication system 704. The authentication system 704 of an embodiment is also referred to herein as the IntelliFinger system 704. The healthcare medical information management system 700 of an embodiment also includes a patient que 606, couplings or connections with an Uncompensated Care Advisor™ and any number N of third-party payers (where N is any number 1, 2 . . . N), and couplings or connections with any number of payment card services (e.g., credit card, debit card, etc.). The patient queue can be integrated with or a component of the EHR system 602 but is not so limited. The healthcare medical information management system 700 can also couple or connect to and/or integrate with one or more other systems (not shown).

The IntelliFinger device 714 of the authentication system 704 is a biometric device coupled to or integrated with at least one application that provides a unique solution for the healthcare industry. The IntelliFinger system 704 and/or Intellifinger device 714 can integrate and interface with existing EHR, practice management (PMS), or hospital information systems (HIS) to provide front-end positive authentication and real-time financial eligibility verification of healthcare patients. The system ensures patient privacy by storing only a numerical representation or two-dimensional (2D) pattern extracted (minutiae points which are the local ridge characteristics that occur either at a ridge ending or a ridge bifurcation) from a live finger image at the point of service that has been run through a secure proprietary algorithm conversion process. The numerical representation of the finger image cannot be reverse-engineered into an actual finger print image nor can it be used to track patients for criminal prosecution.

A biometric finger image system is configured to take or get an image of a finger, and to determine whether the pattern of ridges and valleys in this image matches the pattern of ridges and valleys in pre-scanned images. There are a number of different methods used to get an image of a finger. The most common methods today are optical scanning and capacitance scanning. The IntelliFinger described herein uses the optical scanning method but is not so limited.

The heart of an optical scanner is a charge coupled device (CCD). A CCD is an array of light-sensitive diodes which generate an electrical signal in response to light photons. Typically, an analog-to-digital converter in the scanner system processes the analog electrical signal to generate a digital representation of this image.

The scanning process starts when an individual presses his/her finger on a glass plate, and a CCD camera takes a picture. The scanner has its own light source, typically an array of light-emitting diodes, to illuminate the ridges of the finger. The CCD system actually generates an inverted image of the finger, with darker areas representing more reflected light (the ridges of the finger) and lighter areas representing less reflected light (the valleys between the ridges).

Before converting the image to a number, the scanner processor makes sure the CCD has captured a clear image. The scanner processor checks the average pixel darkness, or the overall values in a small sample, and rejects the scan if the overall image is too dark or too light. If the image is rejected, the scanner adjusts the exposure time to let in more or less light, and then tries the scan again.

If the darkness level is adequate, the scanner system goes on to check the image definition, or the sharpness of the finger image scan). The processor looks at several straight lines moving horizontally and vertically across the image. If the finger image has good definition, a line running perpendicular to the ridges will be made up of alternating sections of very dark pixels and very light pixels. The scanner will then plot the unique patterns of the finger image minutiae and perform a proprietary algorithm that converts the unique pattern into a number. The number is then checked against a stored number to validate the identity of the person.

The IntelliFinger of an embodiment is coupled or connected to, or comprises, any number M (where M is any number 1, 2 . . . M) of interchangeable modular hardware components 604-X (where “X” represents any number 1, 2, . . . ) (e.g., component 1 604-1, component M 604-M, etc.) including, but not limited to, one or more of a magnetic stripe reader, optical or sensor based biometric finger image reader, digital facial camera, document imager, barcode decoder (e.g., one-dimensional (1D) barcode decoder, 2D barcode decoder, etc.), USB 2.0 mini-keyboard, wireless receptor, battery module, SD card, kiosk, and/or printer, to name a few. Each of the components 604-X is described in detail below.

The magnetic stripe reader of an embodiment is configured to read demographic information from a magnetic stripe on the back of driver's license, credit card, or insurance card. The demographic information is shared with the EHR, PMS, or HIS system to provide for an efficient look-up of patient records. Additionally, the magnetic stripe reader can be used to adjudicate financial transactions with credit/debit cards.

An optical or sensor based biometric finger image reader of an embodiment is configured to allow for accurate creation, storage, and comparison of a finger image based on a proprietary algorithm that reads unique ridges, arches, loops, and whirls on the finger minutia and converts those unique data points into a unique numeric representations.

The digital facial camera of an embodiment is configured to allow a photograph to be taken of the patient during point of service. Images may then be stored within the patient record and act as a second form of layered biometrics for identification upon any subsequent visits to the healthcare facility.

The document imager of an embodiment is configured to scan checks, drivers license, and/or insurance cards for subsequent storage as a digitized image within the patient's record.

The barcode decoder of an embodiment is configured to read a barcode for any number of applications including capture of demographic information on the back of driver's licenses that don't include a magnetic stripe and product barcodes that's associated with patient care regiment.

The USB 2.0 ports of an embodiment are configured as a keyboard interface that allows for easy entry of data fields captured by the device and forwarded on to the EHR, PMS, or HIS system. The ports also allow for exchange of patient data via USB based flash (jump) drives and other USB storage media in the future.

The wireless receptor of an embodiment is configured to support 802.11X wireless communication between the device and other nodes on the LAN/WAN network. The wireless receptor can also support other protocols, for example, secure GSM GPRS (EDGE and 3G) based wireless telecommunication networking to name a few.

The battery module of an embodiment is configured to allow fail-over and continued service from a device that has an electrical power failure.

The SD card of an embodiment is configured for caching information that is captured by the IntelliFinger in the event connectivity is lost to the EHR, PMS, or HIS system. Additionally, the SD card provides the potential to store finger image data locally on the device.

The kiosk user interface (e.g., LCD device) is configured to support wireless touch-screen access to any interactive patient form such as first time check-in, reason for visit, or current medications or allergies surveys.

The printer of an embodiment is configured for the capture and printing of a signature on a standardized form such as a Health Insurance Portability and Accountability Act of 1996 (HIPAA) Notification of Privacy Practices Acknowledgement form, printing of a credit card receipt, products and services rendered receipt.

The Intellifinger includes one or more applications that provide a unique solution for the healthcare industry. The applications of an embodiment include, but are not limited to, patient registration, patient authentication, eligibility verification, uncompensated care, survey, and employee tracking to name a few. Each of the IntelliFinger applications is described in detail below.

The patient registration application of an embodiment is configured to perform patient registration functions. When a new patient is registered, the patient is required to enter some demographic information that will identify the patient. If the patient has a valid drivers license or other form of identification that would contain the demographic information on the magnetic stripe, the patient may swipe such identification in the magnetic stripe reader. The patient is then asked to register two finger images (preferably the index fingers) for security and quality of image purposes and their birth date or other form of secondary identification like a phone number. Each finger image is read twice or more to ensure that the quality of the image is such that the numerical representation of the finger image will be accurately read the next time the patient arrives for service (This allows the application to perform a “One-to-Few” search for a match against a live scanned finger image). Once the patient successfully completes this process, the device will send an HL7 version 2.x ADT message(s) to the EHR, PMS, or HIS. The EHR, PMS, or HIS may then store the demographic information in the master patient index.

The patient authentication application of an embodiment is configured to perform patient authentication functions. Subsequent visits to the physician's office by a registered patient require that the patient authenticate their identity by entering their birth date in the device and validating their identity by placing one of their registered index fingers on the biometric reader. The reader will convert the finger image to a secure numeric representation and perform a look-up of that encrypted number in the secure master patient index via a query to the EHR, PMS, or HIS. Upon successfully identifying the patient, the EHR, PMS, or HIS may then load appropriate patient information into the patient queue for the encounter. The IntelliFinger device sends an extracted finger minutiae template from a live finger image scanned to the secure matching server for a match. Once a threshold of positive matching takes place within the matching server, it then sends a secure token including a unique patient ID to the EHR, PMS, or HIS server to release the patient data securely to the point of service workstation that requested and where the original live finger image scan took place.

The eligibility verification application of an embodiment is configured to verify patient eligibility for payment by a third-party payer. At the time of authentication, an ASC X12N 270 v4010 eligibility inquiry is sent in real-time to the appropriate payer. The payer will respond with an ASC X12N 271 v4010 eligibility response which is stored in the EHR, PMS, or HIS.

The uncompensated care application of an embodiment is configured to assess a patient that, while not eligible to receive services paid for by a third-party payer, may be eligible for services paid by another payer. The uncompensated care application includes or is coupled or connected to an Uncompensated Care Advisor™ (UCA) that may be configured in many different ways. The UAC may be automatically executed at the time of the eligibility verification or it may be triggered upon failure of eligibility verification. The execution of the functionality may be defined by the business rules of the organization utilizing the functionality. The Uncompensated Care Advisor will perform address verification, predict payment likelihood, advises on whether the patient is eligible for Medicaid, and whether or not they are available for charity care.

The survey application of an embodiment is configured to support capture of information as defined by the host organization. An example of this tool is new patient surveys that are given to any new patient in a healthcare setting. The patient is allowed to share information or data (e.g., regarding allergies, medications, existing problems, etc.) with the treatment organization prior to being seen by a physician. The patient information is captured by the device via keystroke entry and passed to the EHR, PMS, or HIS for storage in the patient record.

The employee tracking application of an embodiment is configured to track employee time whether in an exam room or for the work shift. The employee can use the employee tracking application to indicate whether the time log is logging in or out via a key press and then verification of the employee identity is captured with the biometric finger image reader. The tracking of time in an exam room may be particularly important when making coding decisions based on the complexity of and time spent on the encounter.

The healthcare medical information management system 600/700 can also couple or connect to and/or integrate with one or more other systems, as described above. As an example, the healthcare medical information management system 600/700 can couple or connect to and/or integrate with providers or systems in order to perform prediction of payment, customized reporting, charity screening for uninsured and/or underinsured patients, automated charity processing, Medicaid screening, and address verification. One example of such providers or systems is SearchAmerica, but the embodiment is not so limited.

Using SearchAmerica as an example third-party provider or system, healthcare medical information management system 600/700 provides access via SearchAmerica to all credit bureaus and other leading data sources, returning the most current information available. The healthcare medical information management system 600/700 also provides access via SearchAmerica to a Payment Advisor™ that provides a prediction of payment likelihood and validates and corrects patient address information in real time. Using a healthcare specific predictive model, patients are categorized based on their financial situation and matched to the most appropriate payment workflow. Payment Advisor is seamlessly integrated into the patient registration process via the healthcare medical information management system 600/700 and returns customized workflow suggestions to guide the registration staff or financial counselor. The healthcare medical information management system 600/700, via Payment Advisor, reduces errors and fraud, encourages increased up-front collections and improves efficiency of your overall collection process. The healthcare medical information management system 600/700, via Payment Advisor, also lists patient credit cards with available resources, which may be used, if needed. Additionally, a summary of the patient's credit history is provided via the healthcare medical information management system 600/700 which includes revolving accounts, installment accounts such as mortgages and car loans, as well as public records.

The healthcare medical information management system 600/700 also provides access via SearchAmerica to a Charity Advisor that is configured to use multiple consumer data sources to screen for Charity/Uninsured discounts in a non-discriminatory way by using estimates for patient income, household size and assets. The healthcare medical information management system 600/700, via Charity Advisor, produces the necessary documentation for charity care and/or uninsured evaluation and automatically calculates discounts based on each provider's unique Charity/Uninsured discount policy. The healthcare medical information management system 600/700, via Charity Advisor, additionally tracks charity processing to make auditing easy. Within seconds from an initial Charity Advisor request received via the healthcare medical information management system 600/700, the Charity Advisor returns a screening status indicating the likelihood of the patient qualifying for the provider's charity programs. The healthcare medical information management system 600/700, via Charity Advisor, populates the provider's specific Charity forms and monitors the charity process to ensure compliance. The healthcare medical information management system 600/700, via Charity Advisor, enables providers to properly classify bad debt as charity to support their community benefit.

The healthcare medical information management system 600/700 also provides access via SearchAmerica to a Medicaid Advisor that is configured to allow providers to focus their staffs Medicaid enrollment efforts on only those patients most likely to qualify for Medicaid. The healthcare medical information management system 600/700, via Medicaid Advisor, screens for Medicaid eligibility using estimates for income, household size and assets. The sophisticated Medicaid Advisor Screening Wizard screens for Medicaid eligibility using the unique income and eligibility requirements from each state. If the patient is found not to be eligible for Medicaid, the system automatically suggests a Charity workflow and transfers all of the information collected up to that point into the Charity Advisor solution.

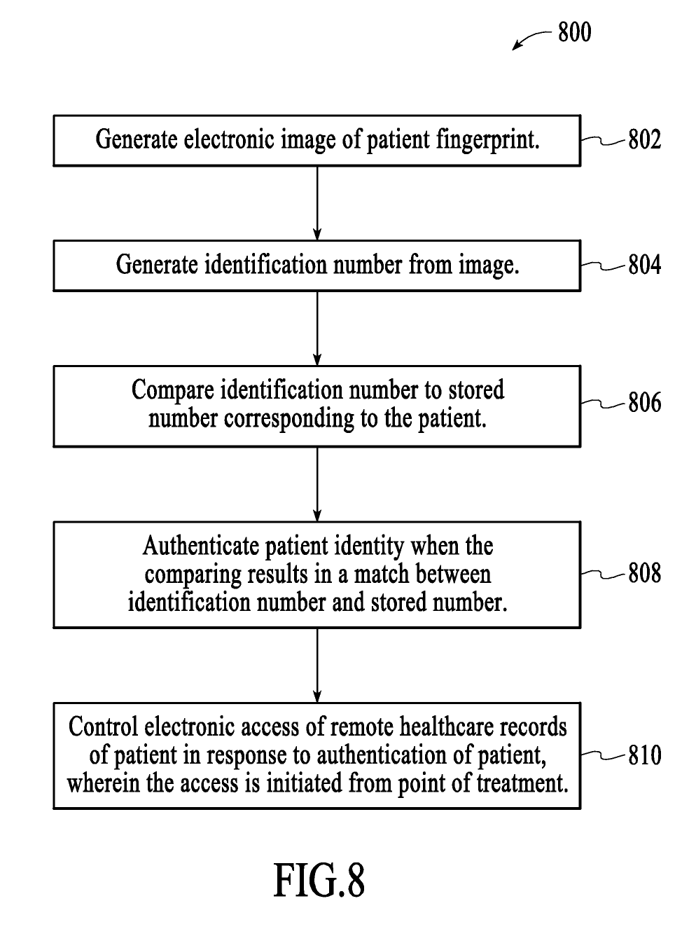

FIG. 8 is a flow diagram of a method 800 for controlling electronic access to healthcare records, under an embodiment. The method 800 includes generating 802 an image of a finger print of a patient, where the image is electronic. An identification number is generated 804 from the image. The identification number is compared 806 to a stored number corresponding to the patient, and the patient's identity is authenticated 808 when the comparing results in a match between the identification number and the stored number. Electronic access of remote healthcare records of the patient is controlled 810 in response to the authenticating of the patient, wherein the access of the healthcare records is initiated from the point of treatment.

The IntelliFinger described above generally operates according to the methods of operation described herein, in particular with reference to FIGS. 5 and 8. The following description includes example operations of the IntelliFinger and interactions between IntelliFinger, the patient, registration personnel, and the healthcare workers providing the care. The IntelliFinger of an embodiment includes four categories of operations, including check in operations, check out operations, enrollment operations, and re-master identification operations, each of which are described in detail below.

Check-in operations are used for existing patient registration where the patient has, at some time in the past, enrolled with the IntelliFinger system. Patient check-in operations include, but are not limited to the following operations.
1. Patient arrives at the care facility for service.
2. Check In option on IntelliFinger device is chosen by pressing a key (e.g., the number 1 key on a keypad) on the device.
3. The patient is asked to enter their registered date of birth in the following format MM DD YYYY where MM=two digit birth month, DD=two digit birth day, YYYY=four digit birth year. The patient presses the <Enter> key upon successful entry of the birth date.
4. The patient places a registered index finger on the IntelliFinger device to authenticate his/her identity.
5. The IntelliFinger device performs an analysis against the unique ridges, loops, arches, and whirls of the finger image in order to calculate a unique identifier for the patient. The device then sends a HL7 ADT version 2.X request to the EHR, PMS, or HIS to locate the patient information matching the unique identification number for the patient. The IntelliFinger device sends an extracted finger minutiae template from a live finger image scan to the secure matching server for a matching. Once a threshold of positively matching takes place within matching server, it then sends a secure token containing unique patient id to the EHR, PMS, or HIS server to release the patient data securely to the point of service workstation that requested and where the original live finger image scan took place.
6. If not found the patient identifier may need to be re-mastered, as described in detail below.
7. If found, demographic and insurance information is pulled from the EHR, PMS, or HIS master patient index and an ASC X12N 270 Version 4010 Eligibility Request is sent to the appropriate payer.
8. The payer will return an ASC X12N 271 Version 4010 Eligibility Response.
9. If the patient is eligible for insurance any co-pay is collected by asking the patient to swipe a credit or debit card through the card swipe on the IntelliFinger device or pay cash. If using a credit card, the IntelliFinger is coupled to a payment card clearance facility (e.g., payment card clearance 610, FIG. 6) and transmits received payment card information to the facility. Following approval of the payment card payment request, the IntelliFinger device prints the receipt for signature and a copy for the patient.
10. If the patient is not eligible for insurance, IntelliFinger will submit an uncompensated care request to the Uncompensated Care Advisor using the ASC X12N 270 Version 4010 Eligibility Request transaction. The Uncompensated Care Advisor will perform address verification, predict payment likelihood, advises on whether the patient is eligible for Medicaid, and whether or not the patient is eligible for charity care.
11. If the patient is not able to pay, the host care facility will make the determination as to whether or not service will be provided.
12. If the patient is accepted for service by the healthcare provider, IntelliFinger surveys the patient for changes to their medical condition and/or any other type of survey for which the facility would like to gather information. The patient is asked what language they would like to use for the survey. Example questions include, but are not limited to, the following:
   a. Do you smoke?
   b. Do you drink?
   c. Have you seen a dentist since your last visit?
   d. Do you have allergies?
   e. Are you on medication?
   f. Other questions as determined by the facility.
13. Once the questionnaire is completed, IntelliFinger will queue the patient record to a patient que (e.g., patient que 606, FIG. 6) and show that the patient is in the waiting room awaiting assignment to an exam room.
14. Download and compare CCR data on patient-provided flash drive (e.g., via USB interface) to the data in the data repository and update if necessary during the check in process.

Check-out operations are used for patients previously queued for service or treatment. Patient check-out operations include, but are not limited to the following operations.
1. Patient receives service from the healthcare provider and proceeds to the check out window.
2. Check Out option on IntelliFinger device is chosen by pressing a key of the device (e.g., the number 2 key on a keypad or screen).
3. The patient is asked to enter their date of birth in the following format MM DD YYYY where MM=two digit birth month, DD=two digit birth day, YYYY=four digit birth year. The patient presses the <Enter> key upon successful entry of the birth date.
4. The patient places a registered finger on the IntelliFinger device to authenticate their identity.
5. The IntelliFinger device performs an analysis against the unique ridges and valleys of the finger image in order to calculate a unique identifier for the patient. The device sends an HL7 ADT version 2.4 request to the EHR, PMS, or HIS to check the patient out of the queue. The patient may then leave the facility.
6. Download updated CCR to patient's flash drive via USB interface or/and trigger an event to send the CCR data via secure email to the patient during the checkout process.

Patient enrollment operations are used for new patient registration or existing patients who have not yet registered through IntelliFinger. The enrollment is generally done in the presence of an Enrollment Administrator to insure enrolling quality images as well as use of the correct fingers (index), but the operations are not so limited. Patient enrollment operations include, but are not limited to the following operations.
1. Patient arrives at the facility for service.
2. Enroll option on IntelliFinger device is chosen by pressing a key (e.g., the number 3 key on the device) by an Enrollment Administrator to conduct an assisted finger image enrollment. This will insure that the captured finger images are of the highest quality. A pass code will be entered by the Enrollment Administrator to enable the enrollment process.
3. The patient is asked whether they are an existing (e.g., option 1) or new (e.g., option 2) patient.
4. Regardless of the option chosen, demographic information such as name, address, city, state, zip code, sex, and date of birth will be gathered to identify the patient for future visits. The patient is asked to scan, swipe or type a primary identification card. The primary ID may be the patient's driver's license, credit card, or insurance card. For purposes of this example, a driver's license is used.
   a. If the patient's driver's license only has a bar code on the back, the driver's license may be scanned using the bar code reader on IntelliFinger.
   b. If the patient's driver's license has a magnetic stripe on the back, the drivers license may be swiped in the magnetic stripe portion of IntelliFinger
   c. If the patient's driver's license does not have either or the patient does not have a driver's license or other form of identification, the patient will be asked to enter demographic information via the attached keyboard.
5. The patient is then asked to master their finger image in IntelliFinger. The IntelliFinger device performs an analysis against the unique ridges and valleys of the finger image in order to calculate a unique identifier for the patient. The mastering process of an embodiment includes but is not limited to the following:
   a. Patient is asked to place a finger on the IntelliFinger device and the Enrollment Administrator will press the <Enter> key when the quality of the finger image is acceptable.
   b. Patient is asked to repeat placing the same finger on the IntelliFinger device and the Enrollment Administrator will press the <Enter> key when the quality of the finger image is acceptable.
   c. Patient is asked to place a second finger, from the opposite hand if possible, on the IntelliFinger device and the Enrollment Administrator will press the <Enter> key when the quality of the finger image is acceptable.
   d. Patient is asked to repeat placing the second finger on the IntelliFinger device and the Enrollment Administrator will press the <Enter> key when the quality of the finger image is acceptable.
6. If the patient is an existing patient that has not registered through IntelliFinger previously, IntelliFinger will attempt to locate the patient in the EHR, PMS, or HIS system by sending a HL7 ADT version 2.X request to the EHR, PMS, or HIS to locate the patient matching demographic information. If found, the registration personnel will validate the patient's identity and the patient identifier will be attached to their medical history information. If the patient is not found in the existing electronic data stored in the EHR, PMS, or HIS system, the registration personnel will notify the appropriate personnel within the facility and a new record will be created. The check in process will then continue.
7. An ASC X12N 270 Version 4010 Eligibility Request is sent to the appropriate payer.
8. The payer will return an ASC X12N 271 Version 4010 Eligibility Response.
9. If the patient is eligible for insurance, any co-pay is collected by asking the patient to swipe a credit or debit card through the card swipe on the IntelliFinger device or pay cash. If using a credit card, the IntelliFinger device will print the receipt for signature and a copy for the patient.
10. If the patient is not eligible for insurance, IntelliFinger will submit an Uncompensated Care Advisor request using the ASC X12N 270 Version 4010 Eligibility Request transaction. The Uncompensated Care Advisor will perform address verification, predict payment likelihood, advise on whether the patient is eligible for Medicaid, and whether or not they are available for charity care.
11. If the patient is not able to pay the facility will make the determination as to whether or not service will be provided.
12. If the patient is accepted for service by the healthcare provider, IntelliFinger will survey the patient for changes to their medical condition or any other type of survey for which the facility would like to gather information. The patient is asked what language they would like to use for the survey. Example questions include:
   a. Do you smoke?
   b. Do you drink?
   c. Have you seen a dentist since your last visit?
   d. Do you have allergies?
   e. Are you on medication?
   f. Other questions as determined by the facility
13. Once the questionnaire is completed, IntelliFinger will queue the patient record and show that the patient is in the waiting room awaiting assignment to an exam room.

Re-master ID operations of an embodiment are used for existing patients whose finger image or key pointer identification (e.g., date of birth, phone number, etc. used for database pointer) has changed since the initial mastering event. The ID re-mastering operations are generally done in the presence of an Enrollment Administrator to insure enrolling quality images as well as use of the correct fingers (index), but the operations are not so limited. Patient ID re-mastering operations include, but are not limited to, the following operations.
1. Patient arrives at the facility for service and is not able to be identified by their originally mastered finger image for whatever reason. The patient must then re-master their ID.
2. Re-master ID option on IntelliFinger device is chosen by pressing a key (e.g., the number 4 key) on the device. A pass code will be entered by the Enrollment Administrator to enable the enrollment process.
3. Demographic information such as name, address, city, state, zip code, sex, and date of birth will be gathered to identify the patient. The patient is asked to scan, swipe or type a primary ID. The primary ID may be the patient's driver's license, credit card, or insurance card. For purposes of this example, a driver's license is used.
   a. If the patient's driver's license only has a bar code on the back, the driver's license may be scanned using the bar code reader on IntelliFinger.
   b. If the patient's driver's license has a magnetic stripe on the back, the drivers license may be swiped in the magnetic stripe portion of IntelliFinger
   c. If the patient's driver's license does not have either or the patient does not have a driver's license or other form of identification, the patient will be asked to enter demographic information using the attached keyboard.
4. The patient is then asked to master their finger image in IntelliFinger. The IntelliFinger device performs an analysis against the unique ridges and valleys of the finger image in order to calculate a unique identifier for the patient. The mastering process includes, but is not limited to, the following:
   a. Patient is asked to place a finger on the IntelliFinger device and the Enrollment Administrator will press the <Enter> key when the quality of the finger image is acceptable.
   b. Patient is asked to repeat the placing the same finger on the IntelliFinger device and the Enrollment Administrator will press the <Enter> key when the quality of the finger image is acceptable.
   c. Patient is asked to place a second finger, from the opposite hand if possible, on the IntelliFinger device and the Enrollment Administrator will press the <Enter> key when the quality of the finger image is acceptable.
   d. Patient is asked to repeat the placing the second finger on the IntelliFinger device and the Enrollment Administrator will press the <Enter> key when the quality of the finger image is acceptable.
5. IntelliFinger will attempt to locate the patient in the EHR, PMS, or HIS system by sending a HL7 ADT version 2.x request to the EHR, PMS, or HIS to locate the patient matching demographic information. If found, the registration personnel will validate the patient's identity and the new patient identifier will be attached to their medical history information. If the patient is not found in the existing electronic data stored in the EHR, PMS, or HIS system, the registration personnel will notify the appropriate personnel within the facility and a new record will be created. The check in process will then continue.
6. If found, demographic and insurance information is pulled from the EHR, PMS, or HIS master patient index and an ASC X12N 270 Version 4010 Eligibility Request is sent to the appropriate payer.
7. The payer will return an ASC X12N 271 Version 4010 Eligibility Response.
8. If the patient is eligible for insurance, any co-pay is collected by asking the patient to swipe a credit or debit card through the card swipe on the IntelliFinger device or having the patient pay cash. If using a credit card, the IntelliFinger device will print the receipt for signature and a copy for the patient.
9. If the patient is not eligible for insurance, IntelliFinger will submit an Uncompensated Care Advisor request using the ASC X12N 270 Version 4010 Eligibility Request transaction. Uncompensated Care Advisor will perform address verification, predict payment likelihood, advises on whether the patient is eligible for Medicaid, and whether or not they are available for charity care.
10. If the patient is not able to pay the facility will make the determination as to whether or not service will be provided.
11. If the patient is accepted for service by the healthcare provider, IntelliFinger will survey the patient for changes to their medical condition or any other type of survey for which the facility would like to gather information. The patient is asked what language they would like to use for the survey. Example questions of an embodiment include, but are not limited to the following:
   a. Do you smoke?
   b. Do you drink?
   c. Have you seen a dentist since your last visit?
   d. Do you have allergies?
   e. Are you on medication?
   f. Other questions as determined by the facility
12. Once the questionnaire is completed, IntelliFinger will queue the patient record and show that the patient is in the waiting room awaiting assignment to an exam room.

The Intellifinger system of an embodiment includes an interface for use between an electronic record system (e.g., EHR) and an end-user console, terminal or device (e.g., Intellifinger device). The electronic record system includes, for example, the eMedicalFiles (eMF) Electronic Health Record (EHR) system. The end-user console, terminal or device includes, but is not limited to, the Intellifinger device, or a modular device configured for electronic transaction processing and configured to receive biometric information of a user. The interface is a real-time, discreet messaging interface configured in accordance with the HL7 standard. The flow of communication is bi-directional with events occurring in the EHR or in the terminal triggering the output of HL7 XML Admission/Transfer/Discharge (ATD)-formatted messages. The ADT messages are communicated out from the EHR system independently from other types of outbound messages (e.g., exam or procedure orders). These ADT messages are routed to the interface engine. An example architecture for communication between EHR and the Intellifinger device uses a SOAP Listener and transfers messages via a SOAP channel. The interface engine filters out any unnecessary transactions and performs other message manipulations, before passing transactions to the Intellifinger device. The Intellifinger device is responsible for acknowledging receipt of a message in accordance with HL7 Original Mode acknowledgment guidelines. Finally, each successfully communicated message is processed by the Intellifinger device and its database is populated accordingly.

The IntelliFinger of an embodiment receives inputs under one or more industrial standard messaging or EDI protocols, and filters, maps, and converts the inputs to provide outputs under one or more different messaging protocols. The Intellifinger output interacts with a biometric device for user authentication to provide a point of service that further aids in payment adjudication process or other financial services, clinical survey, or patient portal services with third party vendors.

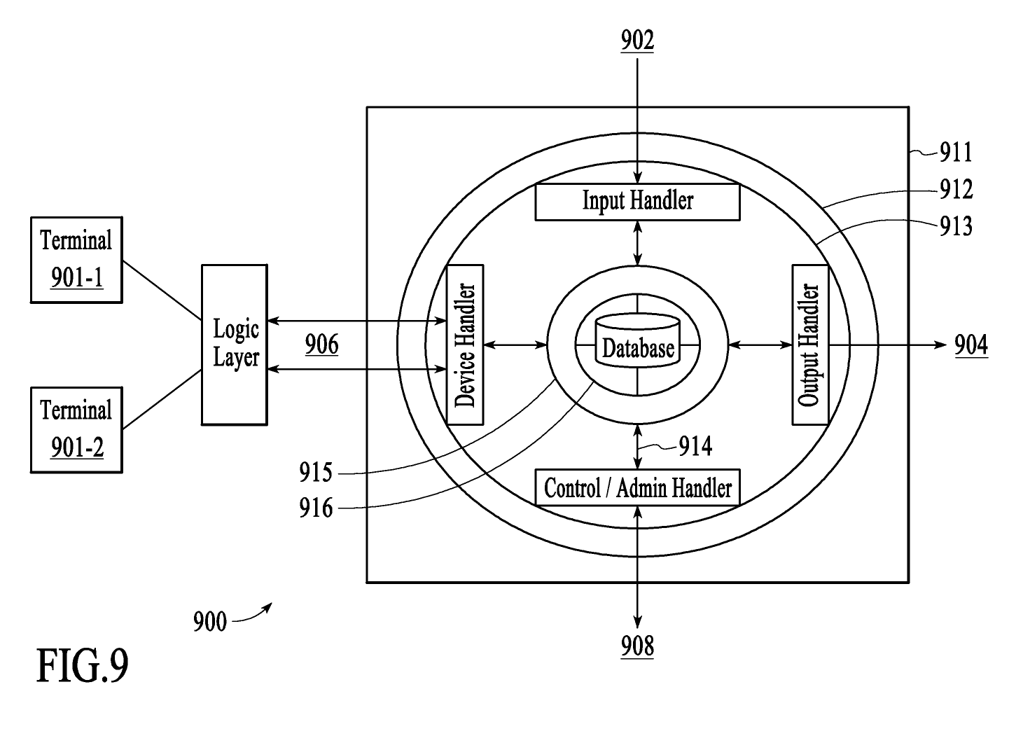

The Intellifinger includes an interface engine which, in an embodiment, is an open source cross-platform HL7 interface engine. FIG. 9 is a block diagram of the interface 900, under an embodiment. The interface 900 is coupled between an electronic record system (e.g., EHR) and an end-user console, terminal or device 901-X (where “X” represent any number 1, 2, . . . ) (e.g., Intellifinger device). The interface 900 of an embodiment includes an input handler 902, output handler 904, device or external interface handler 906, and administrative configuration and data mapping tool 908. The input handler 902 manages inputs associated with a biometric template key assigned by the biometric matching engine 906 during the enrollment process. The output message of the output handler may have a different key value association from the input key value or append the biometric template key value to the original input message. An example interface has the IntelliFinger assign a global key value 906 and pass the message as HL7-A04 event to a third party system 904; this interface has no requirement for an input handler 902.

The Intellifinger interface 900 of an embodiment includes an input handler 902 for five (5) classes of input types; X12 (271, 837, and other EDI), HL7 (2.x), XML based, delimited/parse method, customized API. These message handlers are built in to the interface 900 with exception of the customized API.

The interface 900 of an embodiment includes an output handler 904 that provides outputs in X12 (270, 837, and other EDI), HL7 (2.x), XML based, delimited/parse method, ODBC, customized API, and customizable reporting capability using Jasper open source reporting tool. The interface 900 of an embodiment can be interfaced with the Jasper reporting tool for customizable report generation.

The device or external interface handler 906 of an embodiment handles interfaces including the biometric device via proprietary matcher server, POS device interaction, and other external interfaces. The device interface handler 906 of an embodiment uses the SOAP protocol but is not so limited. The administrative configuration and data mapping tool 908 handles system configuration as well as input data mapping, filtering, and conversion protocol to the output format(s).

The interface 900 of an embodiment includes a security layer 911, communication layer 912, transactions manager layer 913, internal messaging layer 914, internal message (translation) hub layer 915, and business rule layer 916. The security layer 911 handles encryptions, secure connections, and hashing to name a few. The communication layer 912 handles communications including but not limited to MLLP over TCP, web services, HTTP post, POP3, ODBC, File (CCD, CCR, delimited, fix length, formatted PDF, etc.), FTP, and SFTP to name a few. The transactions manager layer 913 includes a batch or multi-thread and multi-session management system. The internal (filtering, transaction, event) messaging layer 914 functions to filter and automate triggers based on mapping protocol set within the admin data filtering, mapping, and conversion process. The internal message (translation) hub layer 915 includes message translation, conversion, and building or generation. The business rule layer 916 handles assignment of biometric key values to new message protocols. The business rule layer 916 of an embodiment is also responsible for merging records.

The interface 900 of an embodiment supports a single input and biometric authentication process outputting to multiple subsystems in multiple protocols as needed. For example, an outpatient enrollment (input) event from integrated partner's legacy system is associated with a biometric key value and then output as a patient update event, or a patient data event is merged back to the same system and sent with biometric key to other subsystems (e.g., Radiology, Lab, prescription, etc.).

The device interface 900 of an embodiment allows the terminal to query the system, including other systems to which the host system is coupled, for other data relating to a patient using a biometric template key and/or primary patient identification information. This includes, in an embodiment, pass through queries to integrated subsystems.

Example use case scenarios of an embodiment include enrolling a new patient, remastering enrollment of a previously enrolled patient, check-in of a patient, check-out of a patient, and purging of patient data. Each use case scenario is described in detail below.

The enrollment of a new patient under an embodiment includes an Enrollment Specialist performing an assisted enrollment of a new patient using the IntelliFinger device, and is successful when the new patient is successfully enrolled in the biomentric data vault and new patient data has been successfully created. New patient enrollment includes use of a magnetic strip mode, a two-dimensional (2D) bar code mode, and a manual mode, each of which is described below.

New patient enrollment using the magnetic strip mode includes the following: Enrollment Specialist selects to enroll new patient from IntelliFinger device menu after a security PIN is entered and selects Mag-Stripe enrollment method; system asks to Enrollment Specialist to swipe the patient's mag-striped ID card such as driver's license after validating the patient's picture ID; system asks Enrollment Specialist to place patient's right index finger on the scanner; system captures patient's right index finger image; system asks Enrollment Specialist to place patient's right index finger again on the scanner for verification; system captures patient's right index finger image and then validates against to previous finger image captured; system asks Enrollment Specialist to place patient's left index finger on the scanner; Enrollment Specialist places patient's left index finger on the scanner; system captures patient's left index finger image; system asks Enrollment Specialist to place patient's left index finger again on the scanner for verification; Emollment Specialist places patient's left index finger again on the scanner; system captures patient's left index finger image and then validates against the previous finger image captured; system informs the Enrollment Specialist that the patient has been successfully enrolled.

New patient enrollment using the magnetic strip mode includes the following optional processes: capture color VGA+quality picture of the enrolling patient; and system facilitates and Enrollment Specialist confirms patient signed the HIPAA consent.

New patient enrollment using the 2D bar code mode includes the following: Enrollment Specialist selects to enroll new patient from IntelliFinger device menu after a security PIN is entered and selects 2D bar code enrollment method; system asks to Enrollment Specialist to present the patient's 2D bar code ID card such as driver's license after validating the patient's picture ID; system asks Enrollment Specialist to place patient's right index finger on the scanner; system captures patient's right index finger image; system asks Enrollment Specialist to place patient's right index finger again on the scanner for verification; system captures patient's right index finger image and then validates against to previous finger image captured; system asks Enrollment Specialist to place patient's left index finger on the scanner; Enrollment Specialist places patient's left index finger on the scanner; system captures patient's left index finger image; system asks Enrollment Specialist to place patient's left index finger again on the scanner for verification; Enrollment Specialist places patient's left index finger again on the scanner; system captures patient's left index finger image and then validates against the previous finger image captured; system informs the Enrollment Specialist that the patient has been successfully enrolled.

New patient enrollment using the 2D bar code mode includes the following optional processes: capture color VGA+quality picture of the enrolling patient; and, system facilitates and Enrollment Specialist confirms patient signed the HIPAA consent.

New patient enrollment using the manual mode includes the following: Enrollment Specialist selects to enroll new patient from IntelliFinger device menu after a security PIN is entered and selects Manual enrollment method; system asks Enrollment Specialist to enter patient's Primary ID; Enrollment Specialist enters the patient's Primary ID; system asks Enrollment Specialist to enter patient's Name; Enrollment Specialist enters the patient's Name; system asks Enrollment Specialist to enter patient's Address; Enrollment Specialist enters patient's Address; system asks Enrollment Specialist to enter patient's Gender; Enrollment Specialist enters patient's Gender; system asks Enrollment Specialist to enter patient's Birthdate; Enrollment Specialist enters patient's Birthdate; system asks Enrollment Specialist to enter patient's Expiration ID; Enrollment Specialist enters patient's Expiration ID; system asks Enrollment Specialist to place patient's right index finger on the scanner; Enrollment Specialist places patient's right index finger on the scanner; system captures patient's right index finger image; system asks Enrollment Specialist to place patient's right index finger again on the scanner for verification; system captures patient's right index finger image and then validates against to previous finger image captured; system asks Enrollment Specialist to place patient's left index finger on the scanner; Enrollment Specialist places patient's left index finger on the scanner; system captures patient's left index finger image; system asks Enrollment Specialist to place patient's left index finger again on the scanner for verification; Enrollment Specialist places patient's left index finger again on the scanner; system captures patient's left index finger image and then validates against the previous finger image captured; system informs the Enrollment Specialist that the patient has been successfully enrolled.

New patient enrollment using the manual mode includes the following optional processes: capture color VGA+quality picture of the enrolling patient; and, system facilitates and Enrollment Specialist confirms patient signed the HIPAA consent.

Remastering patient enrollment under an embodiment includes an Enrollment Specialist performing an assisted remastering of enrollment of an existing patient using the IntelliFinger device, and is successful when the existing patient is successfully remastered in the biomentric data vault and successfully linked to existing patient data. Remastering patient enrollment includes use of a magnetic strip mode, a two-dimensional (2D) bar code mode, and a manual mode, each of which is described below.

Remastering patient enrollment using the magnetic strip mode includes the following: Enrollment Specialist selects to remaster an existing patient from IntelliFinger device menu after a security PIN is entered and selects Mag-Stripe remastering method; system asks to Enrollment Specialist to swipe the patient's mag-striped ID card such as driver's license after validating the patient's picture ID; system finds possible matching patient data from MDAware and Enrollment Specialist confirms the positive match; system asks Enrollment Specialist to place patient's right index finger on the scanner; system captures patient's right index finger image; system asks Enrollment Specialist to place patient's right index finger again on the scanner for verification; system captures patient's right index finger image and then validates against to previous finger image captured; system asks Enrollment Specialist to place patient's left index finger on the scanner; Enrollment Specialist places patient's left index finger on the scanner; system captures patient's left index finger image; system asks Enrollment Specialist to place patient's left index finger again on the scanner for verification; Enrollment Specialist places patient's left index finger again on the scanner; system captures patient's left index finger image and then validates against the previous finger image captured; system informs the Enrollment Specialist that the patient has been successfully enrolled.

Remastering patient enrollment using the magnetic strip mode includes the following optional processes: capture color VGA+quality picture of the enrolling patient; and system facilitates and Enrollment Specialist confirms patient signed the HIPAA consent.

Remastering patient enrollment using the 2D bar code mode includes the following: Enrollment Specialist selects to remaster an existing patient from IntelliFinger device menu after a security PIN is entered and selects 2-D bar code remastering method; system asks to Enrollment Specialist to present the patient's 2-D bar code ID card such as driver's license after validating the patient's picture ID; system finds possible matching patient data from MDAware and Enrollment Specialist confirms the positive match; system asks Enrollment Specialist to place patient's right index finger on the scanner; system captures patient's right index finger image; system asks Enrollment Specialist to place patient's right index finger again on the scanner for verification; system captures patient's right index finger image and then validates against to previous finger image captured; system asks Enrollment Specialist to place patient's left index finger on the scanner; Enrollment Specialist places patient's left index finger on the scanner; system captures patient's left index finger image; system asks Enrollment Specialist to place patient's left index finger again on the scanner for verification; Enrollment Specialist places patient's left index finger again on the scanner; system captures patient's left index finger image and then validates against the previous finger image captured; system informs the Enrollment Specialist that the patient has been successfully enrolled.

Remastering patient enrollment using the 2D bar code mode includes the following optional processes: capture color VGA+quality picture of the enrolling patient; and system facilitates and Enrollment Specialist confirms patient signed the HIPAA consent.

Remastering patient enrollment using the manual mode includes the following: Enrollment Specialist selects to remaster an existing patient from IntelliFinger device menu after a security PIN is entered and selects manual remastering method; system asks Enrollment Specialist to enter patient's Primary ID; Enrollment Specialist enters the patient's Primary ID; system asks Enrollment Specialist to enter patient's Name; Enrollment Specialist enters the patient's Name; system asks Enrollment Specialist to enter patient's Address; Enrollment Specialist enters patient's Address; system asks Enrollment Specialist to enter patient's Gender; Enrollment Specialist enters patient's Gender; system asks Enrollment Specialist to enter patient's Birthdate; Enrollment Specialist enters patient's Birthdate; system asks Enrollment Specialist to enter patient's Expiration ID; Enrollment Specialist enters patient's Expiration ID; system finds possible matching patient data from MDAware and Enrollment Specialist confirms the positive match; system asks Enrollment Specialist to place patient's right index finger on the scanner; Enrollment Specialist places patient's right index finger on the scanner; system captures patient's right index finger image; system asks Enrollment Specialist to place patient's right index finger again on the scanner for verification; system captures patient's right index finger image and then validates against to previous finger image captured; system asks Enrollment Specialist to place patient's left index finger on the scanner; Enrollment Specialist places patient's left index finger on the scanner; system captures patient's left index finger image; system asks Enrollment Specialist to place patient's left index finger again on the scanner for verification; Enrollment Specialist places patient's left index finger again on the scanner; system captures patient's left index finger image and then validates against the previous finger image captured; system informs the Enrollment Specialist that the patient has been successfully enrolled.

Remastering patient enrollment using the manual mode includes the following optional processes: capture color VGA+quality picture of the enrolling patient; and system facilitates and Enrollment Specialist confirms patient signed the HIPAA consent.

Patient check-in under an embodiment includes patient check-in using the Intellifinger device, and is successful when the patient is checked in according to the que. Patient check-in under an embodiment includes the following: patient selects to check-in in Kiosk mode. If there are any questions or other service related issues, the patient interacts with the front desk personnel; system asks patient to enter date of birth; patient enters his/her date of birth; system asks patient to place patient's enrolled index finger on the scanner; patient places an enrolled index finger on the scanner; system captures patient's index finger image; system verifies the captured fingerprint; system informs the patient successfully checked in.

Patient check-in under an embodiment includes the following optional processes: system asks patient to participate in clinical survey; patient inputs the values for the survey into the system; and, system captures patient's picture.

Patient check-out under an embodiment includes patient check-out using the Intellifinger device, and is successful when the patient is checked out according to the que. Patient check-out under an embodiment includes the following: patient selects to check-out in Kiosk mode. If there are any questions or other service related issues, the patient interacts with the front desk personnel; system asks patient to enter date of birth; patient enters his/her date of birth; system asks patient to place patient's enrolled index finger on the scanner; patient places an enrolled index finger on the scanner; system captures patient's index finger image; system verifies the captured fingerprint; system informs the patient successfully checked out.

Patient check-out under an embodiment includes the following optional processes: system captures patient's picture; generate patient's CCR (Continuity of Care Record) data in various mode; printed, USB, etc.; and, system generates CCR (Continuity of Care Record) data for the patient in desired mode.

Purging patient data under an embodiment includes an Enrollment Specialist purging existing patient data from all systems using the IntelliFinger device. Purging of patient data is successful when the patient is successfully purged from the system. Purging patient data under an embodiment includes the following: Enrollment Specialist selects to purge an existing patient from IntelliFinger device menu after a security PIN is entered and selects purging of patient data method; system asks patient to enter date of birth; patient enters his/her date of birth; system asks patient to place patient's enrolled index finger on the scanner; patient places an enrolled index finger on the scanner; system captures patient's index finger image; system verifies the captured fingerprint; system gives final warning before purging the patient data from MDAware; patient gives the final confirmation by entering his/her enrolled date of birth information; system informs the patient successfully purged their data from MDAware system.

Purging patient data under an embodiment includes the following optional processes: system captures patient's picture; generate patient's CCR (Continuity of Care Record) data in various mode, printed, USB, etc.; and, system generates CCR (Continuity of Care Record) data for the patient in desired mode.

Following are specific example deployment configurations of the healthcare medical information management system. These configurations are presented as examples only and are not intended to limit the embodiments presented herein.

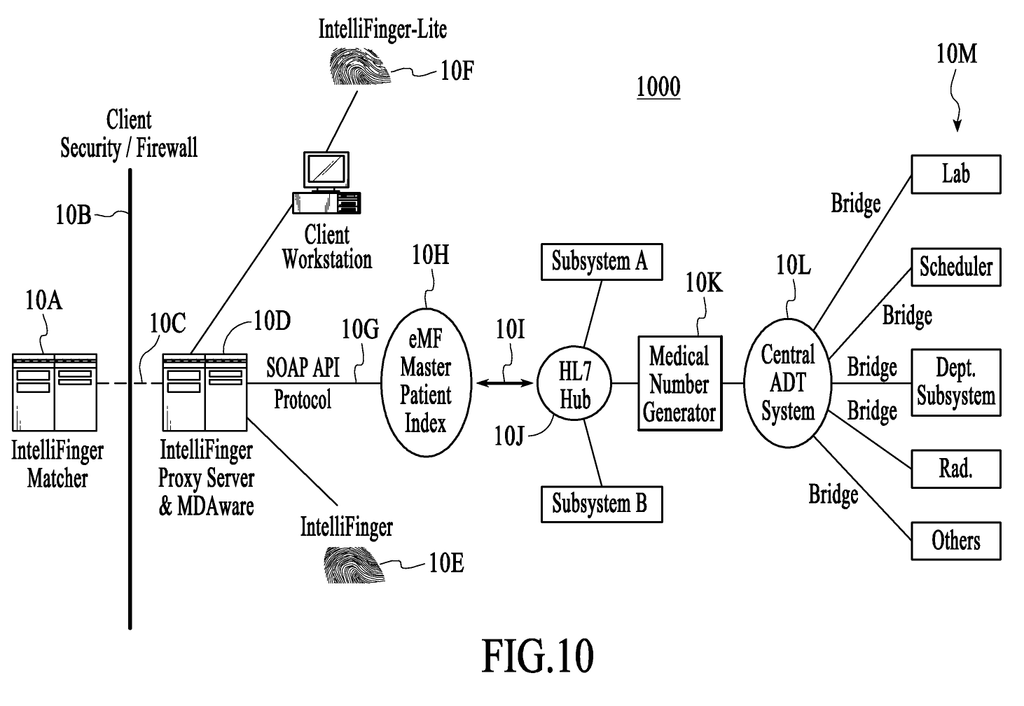

FIG. 10 is a block diagram of an example large scale configuration 1000 of the healthcare medical information management system, under an embodiment. This example system configuration 1000 is in an HL7 ADT HIS environment, but the embodiment is not so limited. The system 1000 includes a matching server 10A outside of the client's firewall, and the matching server 10A is a 1-to-few matching server.

The system 1000 includes a Client Security Firewall 10B that is open for specific VPN IP addresses and ports for the biometric matcher 10A to communicate with the Intellifinger proxy server 10D and optional MDAware™ application within the client secure HIS environment.

The system 1000 includes a Virtual Private Network (VPN) communication tunnel 10C between secure client fire-walled HIS environment and the biometric matcher 10A.

The system 1000 includes a proxy server 10D within the client's firewall because of the closed (secure) network nature of HIS environment. The proxy server 10D routes biometric template extraction(s) from Intellifinger terminals 10E and 10F to the matcher server 10A located outside of the client firewall for biometric authentication. The optional MDAware™ application is used or hosted on the proxy server 10D to support real-time 270/271 edibility verification, address verification, and credit score services.

The system 1000 may include one or more Intellifinger devices 10E as the authentication devices or terminals, as described herein. The Intellifinger device 10E can be used in a standalone configuration, and uses a network drop for TCP/IP LAN communication with the proxy server 10D. The Intellifinger device 10E can be setup as a fixed IP address or DHCP. The biometric enrollment using the Intellifinger device 10E of an embodiment uses the patient's index fingers from right and left hands. If either index finger is missing or damaged during the time of enrollment, the middle finger will be used for enrollment purposes. A two finger enrollment process is used for proper workflow to occur in case the surface of one of the fingers is damaged, because then the other finger will be used for the encounter.

The system 1000 may include one or more Intellifinger-Lite devices 10F as the authentication devices or terminals, as described herein. The Intellifinger-Lite device 10F uses a USB connection or coupling to a host PC (e.g., “client workstation”). The host PC is used to input the patient's date of birth (mm-dd-yyyy format) for 1-to-few biometric matching process as well as inputting patient's new enrollment data or update patient's record. The biometric enrollment using the Intellifinger-Lite device 10F of an embodiment uses the patient's index fingers from right and left hands. If either index finger is missing or damaged during the time of enrollment, the middle finger will be used for enrollment purposes. A two finger enrollment process is used for proper workflow to occur in case the surface of one of the fingers is damaged, because then the other finger will be used for the encounter.

The system 1000 includes a communication protocol 10G between the proxy server 10D and the Master Patient Index System (MPIS) 10H. The protocol 10G is a bi-directional secure and encrypted TCP/IP SOAP (simple object access protocol) XML-based protocol but is not so limited.

The MPIS 10H associates various HIS patient record pointers to a single master patient record pointer by cross-referencing and matching various data elements and primary keys to a threshold matching parameter prior to flagging the record for end-user intervention. For existing patients, the patient data pointer and data is cleansed and the biometric template is then associated with the master key (pointer ID). For new enrollments, the biometric template is associated upfront with assisted enrollment process. Over time, duplicate records are greatly reduced since “false” duplicate record(s) that might still exist in the legacy system will not have an associated biometric key.

The system 1000 includes a communication coupling 101 between the MPIS 10H and HIS. The MPIS 10H can be configured, for example, to send out a HL7 ADT (A01, A08, etc) message to HIS HL7 messaging (gateway) hub 10J which will be distributed to various legacy subsystems or send out any standard protocol to inform legacy subsystems of possible patient data pointer change or data merge. The HIS HL7 communication gateway hub 10J, when included in the system 1000, is a semi-open platform to accept HL7 messages from a secure network nod (PC or server) and distribute the messages to various legacy subsystems for data processing. The MPIS 10H can also be configured to work with HIS master patient medical record number manager 10K. The MPIS 10H will associate the medical record number given by the HIS master medical record number system with the finger image extracted template at the point of treatment.

The system 1000 includes a central HIS HL7 Admission, Discharge, and Transfer (ADT) system 10L that, in an embodiment, is an event driven process within a given hospital-patient workflow. Couplings into the HIS ADT system 10L include but are not limited to an A01 event (Inpatient Admin), A03 event (Discharge), A04 event (Patient Registration), A08 event (update inpatient info), A18 event (Merge Patient Info), and P01 event (Add and Update Outpatient Account).

The system 1000 includes HIS legacy subsystems 10M that may be updated with new patient index keys assigned by the Intellifinger system. The legacy subsystems 10M can include provider department subsystems, laboratory subsystems, scheduler subsystems, and others.

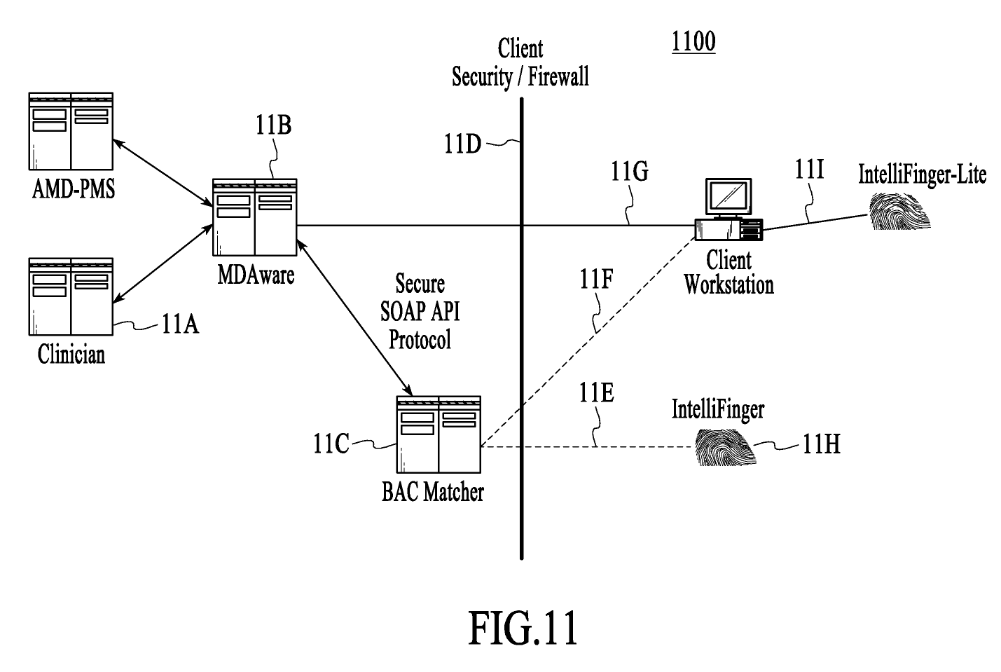

FIG. 11 is a block diagram of an example small scale configuration 1100 of the healthcare medical information management system, under an embodiment. This example system configuration 1100 is in an application service provider (ASP) environment, but the embodiment is not so limited. The system 1000 includes a matching server 10A outside of the client's firewall, and the matching server 10A is a 1-to-few matching server.

The system 1100 includes an AMD-PMS and clinician (lab/prescription) system 10A. The AMD-PMS and clinician system 10A are coupled to the MDAware™ application 11B, which supports real-time 270/271 edibility verification, address verification, and credit score services, resides outside the clients firewall in a secure data center.

The system 1100 includes a matching server 11C outside of the client's firewall, and the matching server 11C is a 1-to-few matching server. The matching server 11C is coupled to the MDAware™ application. The system 1100 includes a Client Security Firewall 11D that is open for specific VPN IP addresses and ports 11E/11F/11G for the biometric matcher 11H and 11I to communicate with the matching server 11C and MDAware™ application 11B.

The system 1100 may include one or more Intellifinger devices 11H as the authentication devices or terminals, as described herein. The Intellifinger device 11H can be used in a standalone configuration, and uses a network drop for TCP/IP LAN communication with a server. The Intellifinger device 11H can be setup as a fixed IP address or DHCP. The biometric enrollment using the Intellifinger device 11H of an embodiment uses the patient's index fingers from right and left hands. If either index finger is missing or damaged during the time of enrollment, the middle finger will be used for enrollment purposes. A two finger enrollment process is used for proper workflow to occur in case the surface of one of the fingers is damaged, because then the other finger will be used for the encounter.

The system 1100 may include one or more Intellifinger-Lite devices 11I as the authentication devices or terminals, as described herein. The Intellifinger-Lite device 11I uses a USB connection or coupling to a host PC (e.g., “client workstation”). The host PC is used to input the patient's date of birth (mm-dd-yyyy format) for 1-to-few biometric matching process as well as inputting patient's new enrollment data or update patient's record. The biometric enrollment using the Intellifinger-Lite device 10F of an embodiment uses the patient's index fingers from right and left hands. If either index finger is missing or damaged during the time of enrollment, the middle finger will be used for enrollment purposes. A two finger enrollment process is used for proper workflow to occur in case the surface of one of the fingers is damaged, because then the other finger will be used for the encounter.

The Intellifinger system can be a component of a single system, multiple systems, and/or geographically separate systems. The Intellifinger system can also be a subcomponent or subsystem of a single system, multiple systems, and/or geographically separate systems. The Intellifinger system can be coupled to one or more other components (not shown) of a host system or a system coupled to the host system.

One or more components of the Intellifinger system and/or a corresponding system or application to which the Intellifinger system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the Intellifinger system can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

The systems and methods of an embodiment include a system comprising: a database system comprising healthcare records of a patient; a healthcare workstation coupled to the database system, the healthcare workstation located at a point of treatment that is remote to the database system; and an authentication system comprising a processor coupled to the database system, the authentication system generating an image of a finger of the patient at the point of treatment, the authentication system generating from the image an identification number, the authentication system comparing the identification number to a stored number corresponding to the patient, the authentication system authenticating the patient's identity when the comparing results in a match between the identification number and the stored number, the authentication system controlling access of the healthcare records via the healthcare workstation in response to the authenticating of the patient.

The authentication system of an embodiment comprises an authentication terminal and a matching server.

The authentication terminal of an embodiment generates the image of the finger and sends an extracted finger minutiae template to the matching server.

The matching server of an embodiment generates the identification number from the extracted finger minutiae template and compares the identification number to the stored number.

Controlling access of the healthcare records of an embodiment comprises the matching server generating a token in response to the match, and sending the token to the database system, wherein the token controls access to the healthcare records from the healthcare workstation.

The access to the healthcare records from the healthcare workstation of an embodiment is limited to a period of time.

The period of time of an embodiment starts when the patient is authenticated.

The period of time of an embodiment ends when the patient signs out via the authentication system upon departure from the point of treatment.

The period of time of an embodiment ends upon expiration of a second period of time, the second period of time starting when the patient signs out via the authentication system upon departure from the point of treatment.

The system of an embodiment comprises the authentication system enrolling the patient to receive treatment at the remote treatment facility. The enrolling of an embodiment comprises: receiving demographic information from the patient; receiving data of identification media of the patient; and capturing an initial image of the finger of the patient.

The system of an embodiment comprises generating the stored number from the initial image of the finger of the patient, wherein the stored number is a numerical representation of a master pattern extracted from the initial image.

The identification media of an embodiment comprises at least one of a government identification card, passport, credit card, and insurance card belonging to the patient.

The database system of an embodiment is an electronic health record system.

The identification number of an embodiment is a numerical representation of a pattern extracted from the image.

The stored number of an embodiment is a numerical representation of a pattern extracted from a registration image taken of the finger during a preceding registration of the patient.

The authentication system of an embodiment includes an input/output (I/O) device that provides prompts to the patient, and receives inputs from the patient in response to the prompts.

The prompts of an embodiment correspond to components of a survey.

The prompts of an embodiment correspond to components of a questionnaire.

The system of an embodiment comprises a patient que coupled to the authentication system, wherein the patient que is an electronic que that ques the patient for treatment at the point of treatment in response to the authenticating.

The patient que of an embodiment receives the healthcare records from the database system in response to the authenticating.

The system of an embodiment comprises a payment system coupled to the authentication system.

The payment system of an embodiment uses the patient's identity to verify eligibility of the patient for payment by a third-party for healthcare treatment.

The third-party of an embodiment is one or more of an insurance company and a financial institution.

The payment system of an embodiment uses the patient's identity to verify eligibility of the patient for charity healthcare treatment.

The payment system of an embodiment uses the patient's identity to verify an address of the patient.

The payment system of an embodiment uses the patient's identity to predict payment probability of the patient.

The payment system of an embodiment uses the patient's identity to provide a credit history of the patient.

The system of an embodiment comprises an electronic reader coupled to the authentication system, the electronic reader reading demographic information of the patient from media belonging to the patient, wherein the authentication system uses the demographic information to access the healthcare records of the patient.

The system of an embodiment comprises a camera coupled to the authentication system, the camera capturing a facial image of the patient at the point of treatment, wherein the authentication system uses the facial image to identify the patient.

The system of an embodiment comprises a coupling between the authentication system and a practice management system.

The system of an embodiment comprises a coupling between the authentication system and a hospital information system.

The systems and methods of an embodiment include a method comprising: generating an image of a finger print of a patient, wherein the image is electronic; generating from the image an identification number; comparing the identification number to a stored number corresponding to the patient; authenticating the patient's identity when the comparing results in a match between the identification number and the stored number; and controlling electronic access of remote healthcare records of the patient in response to the authenticating of the patient, wherein the access of the healthcare records is initiated from the point of treatment.

The systems and methods of an embodiment include a method comprising: generating an image of a finger print of a patient using an authentication system comprising a processor; generating from the image an identification number; comparing the identification number to a stored number corresponding to the patient; authenticating the patient's identity when the comparing results in a match between the identification number and the stored number; and controlling access of healthcare records of the patient via a healthcare workstation in response to the authenticating of the patient, wherein the healthcare workstation is at a point of treatment and the healthcare records are stored in a remote database system.

Generating the image of an embodiment comprises: generating the image at a point of treatment; and extracting a finger minutiae template from the image.

Generating the identification number of an embodiment comprises generating the identification number from the extracted finger minutiae template.

Controlling access of the healthcare records of an embodiment comprises generating a token in response to the match, and controlling access to the healthcare records from the healthcare workstation in response to the token.

The method of an embodiment comprises limiting the access to the healthcare records from the healthcare workstation to a period of time.

The method of an embodiment comprises starting the period of time when the patient is authenticated.

The method of an embodiment comprises ending the period of time when the patient signs out via the authentication system upon departure from the point of treatment.

The method of an embodiment comprises ending the period of time upon expiration of a second period of time, the second period of time starting when the patient signs out via the authentication system upon departure from the point of treatment.

The method of an embodiment comprises enrolling the patient to receive treatment, the enrolling comprising: receiving demographic information from the patient; receiving data of identification media of the patient; and capturing an initial image of the finger of the patient.

The method of an embodiment comprises generating the stored number from the initial image of the finger of the patient, wherein the stored number is a numerical representation of a master pattern extracted from the initial image.

The identification media of an embodiment comprises at least one of a government identification card, passport, credit card, and insurance card belonging to the patient.

The identification number of an embodiment is a numerical representation of a pattern extracted from the image.

The stored number of an embodiment is a numerical representation of a pattern extracted from a registration image taken of the finger during a preceding registration of the patient.

The method of an embodiment comprises: providing prompts to the patient via an input/output (I/O) device; and receiving inputs from the patient in response to the prompts.

The prompts of an embodiment correspond to components of a survey.

The prompts of an embodiment correspond to components of a questionnaire.

The method of an embodiment comprises queuing the patient in an electronic que at the point of treatment in response to the authenticating.

The method of an embodiment comprises receiving the healthcare records at the electronic que in response to the authenticating.

The method of an embodiment comprises verifying eligibility of the patient for payment by a third-party for healthcare treatment.

The third-party of an embodiment is one or more of an insurance company and a financial institution.

The method of an embodiment comprises verifying eligibility of the patient for charity healthcare treatment.

The method of an embodiment comprises verifying an address of the patient.

The method of an embodiment comprises predicting payment probability of the patient.

The method of an embodiment comprises providing a credit history of the patient.

The method of an embodiment comprises electronically reading demographic information of the patient from media belonging to the patient.

The method of an embodiment comprises accessing the healthcare records of the patient using the demographic information.

The method of an embodiment comprises capturing a facial image of the patient at the point of treatment.

The method of an embodiment comprises identifying the patient using the facial image.

Controlling access of healthcare records of the patient of an embodiment comprises controlling electronic access to an electronic health record system.

Controlling access of healthcare records of the patient of an embodiment comprises controlling electronic access to a practice management system.

Controlling access of healthcare records of the patient of an embodiment comprises controlling electronic access to a hospital information system.

The method of an embodiment comprises authenticating a provider of healthcare services at the point of treatment.

Authenticating of an embodiment comprises controlling electronic access to the healthcare records by the provider.

Controlling access of an embodiment comprises controlling electronic access to an electronic health record system.

Controlling access of healthcare records of the patient of an embodiment comprises controlling electronic access to a practice management system.

Controlling access of healthcare records of the patient of an embodiment comprises controlling electronic access to a hospital information system.

The systems and methods described herein include a system for managing individual healthcare information. The system of an embodiment includes a database system for healthcare information relating to a plurality of patients. The database entries of the healthcare information for each patient are identified only by an identifier code and not identified by name or other biographical information. The system of an embodiment includes an interface to a wide-area computer network. The system of an embodiment includes a plurality of patient tokens, each token associable with an individual patient and portable by the individual patient and having memory in which are storable biographical information identifying the individual patient and an identifier code corresponding to the identifier code in the database system relating to a corresponding entry for the individual patient in the database system. The system of an embodiment includes a plurality of base units remotely located from the database system, each base unit associable with a healthcare provider. The base unit of an embodiment includes a wide-area network interface through which information can be communicated with the database system. The base unit of an embodiment includes a token interface circuit with which any one of the tokens can communicate when placed in proximity with a portion of the token interface circuit. The base unit of an embodiment includes a biometric processor with a sensor. The base unit of an embodiment is configured to support biographical information identifying a patient to be read from the memory of a token only if the biometric processor verifies the patient's identity by determining the patient has a biometric predetermined to be uniquely identifiable with the patient and not identifiable with any other patients. The base unit of an embodiment is configured to support healthcare information entries for the patient to be read from the database system via a wide-area network only if the biometric processor verifies the patient's identity by determining the patient has a biometric predetermined to be uniquely identifiable with the patient and not identifiable with any other patients.

Information is stored in the memory of the token of an embodiment in encrypted format.

The biometric processor of an embodiment is a finger image analyzer, and its sensor is a finger image scanner.

The token of an embodiment is a smart card having a processor.

The token interface circuit of an embodiment is configured to communicate information bi-directionally with a token. The base unit of an embodiment is configured to write the healthcare information for a patient to the database system only if the biometric processor verifies a patient's identity by determining the patient has a biometric predetermined to be uniquely identifiable with the patient and not identifiable with any other patients.

The base unit of an embodiment is configured to permit healthcare information to be read from and written to the database system within a first predetermined time interval after the biometric processor verifies the patient's identity and thereafter prevents healthcare information from being read from and written to the database system until the biometric processor again verifies the patient's identity.

The database system of an embodiment includes a write-only mode in which the database system permits healthcare information for a patient to be written to it during a second predetermined time interval following the first predetermined time interval and does not permit healthcare information to be read from the database system during the second predetermined time interval.

The database system of an embodiment is configured to permit information to be read from the database system by a remote computer via a wide-area network in response to a secure personal identification number received from the remote computer.

The system of an embodiment is configured such that vital medical information for the individual patient is storable in the memory of each the token. The base unit of an embodiment is configured to permit the vital medical information to be read from the token only if the biometric processor verifies the patient's identity.

The system of an embodiment is configured such that insurance information for the individual patient is storable in the memory of each the token. The base unit of an embodiment is configured to permit the insurance information to be read from the token only if the biometric processor verifies the patient's identity.

The system of an embodiment is configured such that prescription information for the individual patient is storable in the memory of each the token. The base unit of an embodiment is configured to permit the prescription information to be read from the token only if the biometric processor verifies the patient's identity.

The systems and methods described herein include a system for managing healthcare patient information storable in a database system and accessible using tokens associated with patients. The system of an embodiment includes a base unit remotely located from the database system. The base unit of an embodiment includes a wide-area network interface through which information can be bi-directionally communicated with the database system. The base unit of an embodiment includes a token interface circuit with which a token can communicate when placed in proximity with a portion of the token interface circuit. The base unit of an embodiment includes a computer interface through which information can be communicated between the base unit and a computer operated by a healthcare professional. The base unit of an embodiment includes a biometric processor with a sensor, the base unit permitting information to be bi-directionally communicated with the database system via a wide-area network only if the biometric processor verifies the patient's identity by determining the patient has a biometric predetermined to be uniquely identifiable with the patient and not identifiable with any other patients. The base unit of an embodiment includes a computer program product for the computer operated by the healthcare professional. The computer program product of an embodiment comprises a data storage medium on which is recorded in computer-readable format a means for causing information read from the database to be displayed on the computer.

The computer program product of an embodiment includes recorded thereon in computer-readable format means for entering diagnosis information by the healthcare professional into the computer and causing the diagnosis information to be written to the database system. The healthcare information stored in the database system of an embodiment includes the diagnosis information. The computer program product of an embodiment includes recorded thereon in computer-readable format means for entering treatment information by the healthcare professional into the computer and causing the treatment information to be written to the database system. The healthcare information of an embodiment stored in the database system includes the treatment information.

The computer program product of an embodiment includes recorded thereon in computer-readable format means for entering prescription information by a physician into the computer and causing the prescription information to be written to a memory of the token.

The computer program product of an embodiment includes recorded thereon in computer-readable format means for reading prescription information from a memory of the token and causing the prescription information to be displayed on the computer for review by a pharmacist. The computer program product of an embodiment includes recorded thereon in computer-readable format means for entering pharmacy information by the pharmacist indicating whether a prescription defined by the prescription information has been filled and causing the pharmacy information to be written to a memory of the token.

The systems and methods described herein include a method for managing healthcare patient information. The method of an embodiment includes enrolling a patient by capturing a biometric uniquely identifiable with the patient and not identifiable with any other patients. The method of an embodiment includes storing healthcare information in a database system. The method of an embodiment includes issuing the patient a token having a memory in which is stored biographical information identifying the patient and an identifier code, database entries for the patient identified only by an identifier code corresponding to the identifier code stored in the memory and not identified by patient name or other biographical information. The method of an embodiment includes interfacing the token issued to the patient with a base unit issued to a healthcare professional. The method of an embodiment includes the base unit obtaining a biometric measurement from the patient. The method of an embodiment includes the base unit verifying the patient's identity by determining whether the measurement has the biometric uniquely identifiable with the patient. The method of an embodiment includes permitting healthcare information entries to be read from the database system only if the patient's identity is verified. The method of an embodiment includes permitting the biographical information to be read from the memory of the token only if the patient's identity is verified.

Capturing a biometric of an embodiment comprises storing captured biometric information in the memory of the token.

The method of an embodiment includes displaying the healthcare information on a display of a computer coupled to the base unit. The method of an embodiment includes permitting healthcare information for the patient to be written to the database system from the computer only if the patient's identity is verified.

The method of an embodiment includes reading the healthcare information from the database if the patient's identity is verified and displaying the healthcare information on a display of a computer coupled to the base unit and operated by a physician. The method of an embodiment includes the physician entering prescription information into the computer and if the patient's identity is verified causing the prescription information to be written to the memory of the token.

The method of an embodiment includes reading the prescription information from the memory of the token if the patient's identity is verified and displaying the prescription information on a display of a computer coupled to the base unit and operated by a pharmacist. The method of an embodiment includes the pharmacist entering into the computer an indication whether the prescription has been filled and if the patient's identity is verified causing the indication to be written to the memory of the token.

Aspects of the Intellifinger system and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the Intellifinger system and corresponding systems and methods include: microcontrollers with memory (such as electronically erasable programmable read only memory (EEPROM)), embedded microprocessors, firmware, software, etc. Furthermore, aspects of the Intellifinger system and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the Intellifinger system and corresponding systems and methods is not intended to be exhaustive or to limit the systems and methods to the precise forms disclosed. While specific embodiments of, and examples for, the Intellifinger system and corresponding systems and methods are described herein for illustrative purposes, various equivalent modifications are possible within the scope of the systems and methods, as those skilled in the relevant art will recognize. The teachings of the Intellifinger system and corresponding systems and methods provided herein can be applied to other systems and methods, not only for the systems and methods described above.

The elements and acts of the various embodiments described above can be combined to provide further embodiments. These and other changes can be made to the Intellifinger system and corresponding systems and methods in light of the above detailed description.

In general, in the following claims, the terms used should not be construed to limit the Intellifinger system and corresponding systems and methods to the specific embodiments disclosed in the specification and the claims, but should be construed to include all systems that operate under the claims. Accordingly, the Intellifinger system and corresponding systems and methods is not limited by the disclosure, but instead the scope is to be determined entirely by the claims.

While certain aspects of the Intellifinger system and corresponding systems and methods are presented below in certain claim forms, the inventors contemplate the various aspects of the Intellifinger system and corresponding systems and methods in any number of claim forms. Accordingly, the inventors reserve the right to add additional claims after filing the application to pursue such additional claim forms for other aspects of the Intellifinger system and corresponding systems and methods.

What is claimed is:

1. A method comprising:
generating an image of a finger print of a patient, wherein the image is electronic;
generating from the image an identification number;
comparing the identification number to a stored number corresponding to the patient;
authenticating the patient's identity when the comparing results in a match between the identification number and the stored number; and
controlling electronic access of remote healthcare records of the patient in response to the authenticating of the patient, wherein the access of the healthcare records is initiated from the point of treatment.

2. A method comprising:
generating an image of a finger print of a patient using an authentication system comprising a processor;
generating from the image an identification number;
comparing the identification number to a stored number corresponding to the patient;
authenticating the patient's identity when the comparing results in a match between the identification number and the stored number; and
controlling access of healthcare records of the patient via a healthcare workstation in response to the authenticating of the patient, wherein the healthcare workstation is at a point of treatment and the healthcare records are stored in a remote database system.

3. The method of claim 2, wherein generating the image comprises:
generating the image at a point of treatment; and
extracting a finger minutiae template from the image.

4. The method of claim 3, wherein generating the identification number comprises generating the identification number from the extracted finger minutiae template.

5. The method of claim 4, wherein controlling access of the healthcare records comprises generating a token in response to the match, and controlling access to the healthcare records from the healthcare workstation in response to the token.

6. The method of claim 5, comprising limiting the access to the healthcare records from the healthcare workstation to a period of time.

7. The method of claim 6, comprising starting the period of time when the patient is authenticated.

8. The method of claim 7, comprising ending the period of time when the patient signs out via the authentication system upon departure from the point of treatment.

9. The method of claim 7, comprising ending the period of time upon expiration of a second period of time, the second period of time starting when the patient signs out via the authentication system upon departure from the point of treatment.

10. The method of claim 1, comprising enrolling the patient to receive treatment, the enrolling comprising:
receiving demographic information from the patient;
receiving data of identification media of the patient; and
capturing an initial image of the finger of the patient.

11. The method of claim 10, comprising generating the stored number from the initial image of the finger of the patient, wherein the stored number is a numerical representation of a master pattern extracted from the initial image.

12. The method of claim 10, wherein the identification media comprises at least one of a government identification card, passport, credit card, and insurance card belonging to the patient.

13. The method of claim 2, wherein the identification number is a numerical representation of a pattern extracted from the image.

14. The method of claim 2, wherein the stored number is a numerical representation of a pattern extracted from a registration image taken of the finger during a preceding registration of the patient.

15. The method of claim 2, comprising:
providing prompts to the patient via an input/output (I/O) device; and
receiving inputs from the patient in response to the prompts.

16. The method of claim 15, wherein the prompts correspond to components of a survey.

17. The method of claim 15, wherein the prompts correspond to components of a questionnaire.

18. The method of claim 2, comprising queuing the patient in an electronic que at the point of treatment in response to the authenticating.

19. The method of claim 18, comprising receiving the healthcare records at the electronic que in response to the authenticating.

20. The method of claim 2, comprising verifying eligibility of the patient for payment by a third-party for healthcare treatment.

21. The method of claim 20, wherein the third-party is one or more of an insurance company and a financial institution.

22. The method of claim 2, comprising verifying eligibility of the patient for charity healthcare treatment.

23. The method of claim 2, comprising verifying an address of the patient.

24. The method of claim 2, comprising predicting payment probability of the patient.

25. The method of claim 2, comprising providing a credit history of the patient.

26. The method of claim 2, comprising electronically reading demographic information of the patient from media belonging to the patient.

27. The method of claim 26, comprising accessing the healthcare records of the patient using the demographic information.

28. The method of claim 2, comprising capturing a facial image of the patient at the point of treatment.

29. The method of claim 28, comprising identifying the patient using the facial image.

30. The method of claim 2, wherein controlling access of healthcare records of the patient comprising controlling electronic access to an electronic health record system.

31. The method of claim 2, wherein controlling access of healthcare records of the patient comprising controlling electronic access to a practice management system.

32. The method of claim 2, wherein controlling access of healthcare records of the patient comprising controlling electronic access to a hospital information system.

33. The method of claim 2, comprising authenticating a provider of healthcare services at the point of treatment.

34. The method of claim 33, wherein authenticating comprises controlling electronic access to the healthcare records by the provider.

35. The method of claim 34, wherein controlling access comprises controlling electronic access to an electronic health record system.

36. The method of claim 34, wherein controlling access of healthcare records of the patient comprising controlling electronic access to a practice management system.

37. The method of claim 34, wherein controlling access of healthcare records of the patient comprising controlling electronic access to a hospital information system.
